(19) United States
(12) Patent Application Publication
(10) Pub. No.: US 2022/0310994 A1
(43) Pub. Date: Sep. 29, 2022

(54) SELECTIVELY PERMEABLE NANOSTRUCTURED MATERIALS

(71) Applicant: Conamix Inc., Ithaca, NY (US)

(72) Inventors: Stephen Burkhardt, Ithaca, NY (US); Christopher A. Simoneau, Trumansburg, NY (US); Larry Beck, Ann Arbor, MI (US); Jay J. Farmer, Ithaca, NY (US)

(21) Appl. No.: 17/619,480

(22) PCT Filed: Jun. 18, 2020
(86) PCT No.: PCT/US20/38508

§ 371 Date: Dec. 15, 2021

Related U.S. Application Data
(60) Provisional application No. 62/863,138, filed on Jun. 18, 2019.
(60) Provisional application No. 62/863,816, filed on Jun. 19, 2019.

(51) Int. Cl. H01M 4/38; C01B 17/02; H01M 4/36; H01M 4/58; H01M 4/62; H01M 10/0525

(52) U.S. Cl. CPC H01M 4/38; C01B 17/0259; C01B 17/0248; H01M 4/366; H01M 4/5815; H01M 4/624; H01M 10/0525; C01P 2004/64; C01P 2006/40; H01M 2004/028

(57) ABSTRACT

This application relates to nanostructured materials having selectively permeable structures that separate a liquid phase contained within the nanostructure from a volume outside of the nanostructure, and methods of making same. Such materials may be used as electrode materials for secondary batteries or other energy storage devices.

### CROSS REFERENCE TO RELATED APPLICATIONS

This application claims priority to and benefit of U.S. Application Ser. No. 62/863,138, filed on Jun. 18, 2019 and U.S. Application Ser. No. 62/863,816, filed on Jun. 19, 2019, the contents of each of which is hereby incorporated by reference in its entirety.

### TECHNICAL FIELD

This application relates to nanostructured materials having selective permeability; such nanostructured materials have utility in the manufacture of electrode compositions for secondary batteries and other energy storage devices.

### BACKGROUND

A major objective in the commercial development of next generation rechargeable batteries is to provide batteries with higher energy densities than state of the art lithium ion batteries. One of the most promising approaches to this goal is use of a sulfur cathode coupled with a lithium metal anode. Sulfur is inexpensive, abundant, and offers a theoretical charge capacity that is an order of magnitude higher than conventional metal oxide-based intercalation cathodes used in current lithium ion cells. Similarly, anodes based on metallic lithium have much higher energy density than the lithium graphite anodes used in current lithium ion cells.

However, the manufacture of a practical lithium sulfur battery has been an elusive goal. Among the challenges that plague sulfur cathodes, one of the most serious arises from dissolution of lithium polysulfide intermediates formed during battery discharge. These compounds are soluble in electrolytes and difficult to retain at the cathode. In addition, sulfide anions are highly nucleophilic which creates incompatibility with many of the chemicals used in commercial lithium ion batteries. In particular, sulfides readily react with the alkylene carbonates that are typically used as electrolytes in lithium ion batteries. Because of this, ethereal electrolytes such as dimethoxyethane (DME) and 1,3-dioxolane (DOL) are widely used in place of carbonates in sulfur batteries. Unfortunately, ethereal solvents are oxidatively unstable, highly flammable, and do not form stable solid electrolyte interfaces (SEIs) on lithium anodes. This is a consternating problem and developing a high-performance system that simultaneously satisfies the divergent demands of sulfur cathodes and lithium metal anodes remains an elusive goal.

### SUMMARY

Although elemental sulfur has been under investigation as a battery cathode material for more than 50 years, fundamental problems have yet to be solved to enable widespread commercialization. Although incremental improvements in capacity and cycle lifetime of lithium sulfur batteries have been made, significant improvements are needed to prevent polysulfide loss and to create system chemistries that are compatible with sulfur chemistry and lithium metal anodes. The present invention provides solutions to these and related problems.

Among other things, the present invention encompasses the recognition that engineered materials having selective permeability can be applied to solve problems in sulfur batteries including preventing polysulfide shuttling and addressing the challenges of combining electrolytes and additives optimized for sulfur in cells with lithium metal anodes. In one aspect, the invention provides nanostructured materials for sulfur cathode construction characterized in that the materials comprise structures that are selectively permeable to one or more components of a liquid phase with which the nanostructured material is in contact. In certain embodiments, the structure having selective permeability has differential permeability based on the size, charge, or polarity of a molecule (or any combination of these features). In certain embodiments, such structures comprise nanofiltration membranes, or compositions with nanofiltration properties.

In certain embodiments, provided nanostructured materials are characterized in that they contain or encapsulate an interior volume that is physically isolated from a volume outside of the nanostructure (e.g. an enclosed volume). In certain embodiments, the present invention provides a nanostructured material comprising a contained volume that is physically separated from a volume outside of the nanostructure, wherein the contained volume encloses a contained electroactive substance and a contained liquid phase in contact with the contained electroactive substance. In certain embodiments, provided nanostructured materials comprise a contained volume that is physically separated from a volume outside of the nanostructure by a permeable membrane, wherein the contained volume encloses an electroactive substance and a contained liquid phase in contact with the electroactive substance. In certain embodiments, provided nanostructured materials comprise a contained volume that is physically separated from a volume outside of the nanostructure by a selectively permeable membrane, wherein the contained volume encloses an electroactive substance and a contained liquid phase in contact with the electroactive substance.

In certain embodiments, the nanostructured material comprises a core shell nanoparticle having a shell with selective permeability. In certain embodiments, such core shell particles are characterized in that the shell encloses a volume in which an electroactive sulfur substance is in contact with a contained liquid electrolyte composition. In certain embodiments, a contained electrolyte composition comprises a mixture of substances to which the shell has different degrees of permeability. In certain embodiments, the shell is impermeable to one or more components of the contained liquid electrolyte, thereby preventing their flow out of the contained volume within the core shell particle. In certain embodiments, the shell is highly permeable to one or more components of the contained liquid electrolyte and such components may flow in and out of the core shell particle. In certain embodiments, the invention encompasses a composition comprising such electrolyte-containing core shell nanoparticles characterized in that an electrolyte composition outside of the shell has a different composition than the electrolyte contained within the shell. In certain embodiments, the shell is impermeable to one or more components of the electrolyte outside of the shell, thereby preventing their flow into the interior volume of the core shell particle.

In another aspect, the present invention provides methods of forming nanostructured materials with selective permeability to one or more components of a liquid phase with which the nanostructured material is in contact. In certain embodiments, provided methods comprise the steps of providing a sulfur-based electroactive material, and coating or encapsulating the sulfur-based electroactive material with a selectively-permeable polymer. In certain embodiments such methods comprise the step of contacting the sulfur-based electroactive material with a monomer (or a mixture of monomers) under conditions that cause the deposition of a selectively-permeable polymer on a surface of the sulfur-based electroactive material. In certain embodiments such methods comprise the step of contacting the sulfur-based electroactive material with a monomer (or mixture of monomers) under conditions that cause the deposition of a polymer layer on the surface of the sulfur-based electroactive material and further treating the polymer to modify its permeability properties. In certain embodiments, the step of further treating the polymer to enhance its selective permeability comprises cross-linking the polymer.

In another aspect, the present invention provides nanostructured materials having an interior liquid phase contained within an interior volume by a selectively-permeable structure (“a contained liquid phase”) wherein the contained liquid phase comprises one or more components to which the selectively permeable structure is substantially impermeable. In another aspect, the present invention provides methods of forming nanostructured materials wherein an interior liquid phase is separated from an exterior liquid phase by a selectively-permeable structure, wherein the contained liquid phase and the exterior liquid phase have different compositions. In certain embodiments, such methods comprise the steps of: placing a nanostructured material having an interior volume in contact with a first liquid phase under conditions that cause the first liquid phase to enter the interior volume of the nanostructured material and then treating the nanostructured material under conditions that modify the permeability of one or more materials composing the nanostructured material such that its permeability to at least one component of the contained liquid phase is decreased. In certain embodiments, the component of the first liquid phase to which the permeability of the nanostructured material is decreased is then substantially unable to diffuse out of the interior volume of the structured nanomaterial (e.g. it is trapped in the interior volume of the nanostructured material). In certain embodiments, the nanostructured material thus formed is contacted with a second liquid phase having a composition different from the first liquid phase contained within the interior volume of the nanostructured material. In certain embodiments, one or more components of the second liquid phase enter the interior volume of the nanostructured material thereby changing its composition.

In another aspect, the present invention provides a system comprising a nanostructured material in contact with a first liquid phase, the nanostructured material comprising a contained volume that encloses a contained electroactive substance and a contained liquid phase in contact with the electroactive substance, wherein the contained liquid phase is physically separated from the first liquid phase by a selectively permeable membrane and wherein at least one of the first liquid phase and the contained liquid phase comprises substances to which the selectively permeable structure is substantially impermeable.

In certain embodiments, provided methods comprise the steps of providing a sulfur-based electroactive material, and coating or encapsulating the sulfur-based electroactive material with a selectively-permeable polymer. In certain embodiments such methods comprise the step of contacting the sulfur-based electroactive material with a monomer (or a mixture of monomers) under conditions that cause the formation of a polymer layer on the sulfur-based electroactive material.

In certain embodiments, the present invention provides methods of forming electrolyte-containing core shell nanoparticles having a contained liquid-phase within an interior volume defined by the shell and characterized in that the shell is permeable to some components of the contained liquid phase and impermeable to other components of the contained liquid phase. Such particles have the property of enabling those components to which the shell is permeable to flow in and out of the core shell particle while retaining those components to which the shell is impermeable within the volume contained by the shell. In certain embodiments, the components of the contained liquid phase to which the shell is impermeable are additives that are beneficial to sulfur electrochemistry.

In certain embodiments, the present invention provides a method of making a nanostructure comprising the steps of: forming a nanoscale particle of an electroactive substance, coating the nanoscale particle with a permeable encapsulant to contain the electroactive substance, reducing the volume of the contained electroactive substance to create a void space contained within the encapsulant, introducing a liquid phase into the void space, and coating the nanoscale particle with a second encapsulant that is impermeable to one or more of the substances in the liquid phase. In certain embodiments, the present invention provides a method of making a nanostructure comprising the steps of: forming a nanoscale particle of an electroactive substance, coating the nanoscale particle with a permeable encapsulant to contain the electroactive substance, reducing the volume of the contained electroactive substance to create a void space contained within the encapsulant, introducing a liquid phase into the void space, and modifying the encapsulant to make it less permeable to one or more substances in the liquid phase. In certain embodiments, the present invention provides a method of making a nanostructure comprising the steps of: forming a hollow structure with a permeable encapsulant, introducing a nanoscale particle of an electroactive substance into the hollow structure, introducing a liquid phase into the void space, and modifying the encapsulant to make it less permeable to one or more substances in the liquid phase. In certain embodiments, the present invention provides a method of making a nanostructure comprising the steps of: forming a hollow structure with a permeable encapsulant; introducing a liquid phase into the void space comprising a dissolved electroactive substance or precursor to the electroactive substance; treating the nanostructure to solidify the dissolved electroactive substance or precursor to the electroactive substance contained in the hollow structure; and modifying the encapsulant to make it less permeable to one or more substances in the liquid phase.

The present invention provides, among other things, compositions that have utility in the construction of cathodes for electrochemical devices. In certain embodiments, the invention provides a cathode composition comprising the provided nanostructured materials. Because of the unique characteristics of the nanostructured materials, such cathode compositions have properties not previously attainable in prior art cathode compositions. In certain embodiments, the selectively permeable nanostructured materials are utilized as an electroactive material in a cathode composition of a secondary alkali metal/sulfur battery. In certain embodiments, such cathode compositions are characterized in that they comprise electroactive sulfur in contact with a contained liquid phase that is physically separated from a volume outside of the nanostructured material wherein the contained liquid phase contains one or more components that are substantially absent from a liquid phase with which the bulk cathode is in contact. In certain embodiments, such cathode compositions are characterized in that they comprise electroactive sulfur in contact with a contained liquid phase that is physically separated from a volume outside of the nanostructured material wherein the contained liquid phase is substantially free of one or more components that are present in a liquid phase with which the bulk cathode is in contact. In certain embodiments, such cathode compositions are characterized in that they comprise electroactive sulfur in contact with a contained liquid phase that is physically separated from a volume outside of the nanostructured material wherein the volume outside of the nanostructured material (e.g. the electrolyte with which the bulk cathode is in contact) is occupied by a solid, or a gel.

The present invention further provides electrochemical devices. In certain embodiments, the invention provides a secondary battery comprising a provided cathode composition. Because of the unique characteristics of the nanostructured materials, such batteries have properties not previously attainable. In certain embodiments, the selectively permeable nanostructured materials are utilized as an electroactive material in the cathode of a secondary sulfur battery. In certain embodiments, such batteries are characterized in that they comprise electroactive sulfur in contact with a contained liquid phase that contains one or more components that are absent from the electrolyte with which the bulk cathode and the anode are in contact. In certain embodiments, such batteries are characterized in that they comprise electroactive sulfur in contact with a contained liquid phase that is substantially free of one or more components that are present in the electrolyte with which the bulk cathode and the anode are in contact. In certain embodiments, such cathode compositions are characterized in that they comprise electroactive sulfur in contact with a liquid phase contained within a volume of the nanostructured material while the electrolyte with which the bulk cathode and anode are in contact comprises a solid or gel electrolyte.

### Definitions

In order for the present disclosure to be more readily understood, certain terms are first defined below. Additional definitions for the following terms and other terms are set forth throughout the specification.

In this application, unless otherwise clear from context, the term “a” may be understood to mean “at least one.” As used in this application, the term “or” may be understood to mean “and/or.” In this application, the terms “comprising” and “including” may be understood to encompass itemized components or steps whether presented by themselves or together with one or more additional components or steps. As used in this application, the term “comprise” and variations of the term, such as “comprising” and “comprises,” are not intended to exclude other additives, components, integers or steps.

About, Approximately: As used herein, the terms “about” and “approximately” are used as equivalents. Unless otherwise stated, the terms “about” and “approximately” may be understood to permit standard variation as would be understood by those of ordinary skill in the art. Where ranges are provided herein, the endpoints are included. Any numerals used in this application with or without about/approximately are meant to cover any normal fluctuations appreciated by one of ordinary skill in the relevant art. In some embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Aliphatic: As used herein, the term “aliphatic” may be understood to encompass a straight-chain (i.e., unbranched) or branched, substituted or unsubstituted hydrocarbon chain that is completely saturated or that contains one or more units of unsaturation, or a monocyclic hydrocarbon or bicyclic hydrocarbon that is completely saturated or that contains one or more units of unsaturation. Unless otherwise specified, aliphatic groups contain 1-12 aliphatic carbon atoms. In some embodiments, aliphatic groups contain 1-6 aliphatic carbon atoms. In some embodiments, the aliphatic groups contain 1-5 aliphatic carbon atoms. In some embodiments, aliphatic groups contain 1-4 aliphatic carbon atoms. In some embodiments aliphatic groups contain 1-3 aliphatic carbon atoms. Suitable aliphatic groups include, but are not limited to, linear or branched, substituted or unsubstituted alkyl, alkenyl, alkynyl groups, and hybrids thereof.

Electroactive Substance: As used herein, the term “electroactive substance” refers to a substance that changes its oxidation state, or partakes in a formation or breaking of chemical bonds, in a charge-transfer step of an electrochemical reaction.

Nanoparticle, Nanostructure, Nanomaterial: As used herein, these terms may be used interchangeably to denote a particle of nanoscale dimensions or a material having nanoscale structures. The nanoparticles can have essentially any shape or configuration, such as a tube, a wire, a laminate, sheets, lattices, a box, a core and shell, or combinations thereof.

Polymer: As used herein, the term “polymer” generally refers to a substance that has a molecular structure consisting chiefly or entirely of repeated sub-units bonded together, such as synthetic organic materials used as plastics and resins.

Substantially: As used herein, the term “substantially” refers to the qualitative condition of exhibiting total or near-total extent or degree of a characteristic or property of interest.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the disclosed compositions and methods and are not intended as limiting. For purposes of clarity, not every component may be labeled in every drawing. In the following description, various embodiments are described with reference to the following drawings, in which:

FIG. 1 is a pictorial representation of a nanostructured material in accordance with one or more embodiments of the invention.

FIG. 2 is another pictorial representation of a nanostructured material in accordance with one or more embodiments of the invention.

FIG. 3 is a cross-sectional representation of a nanoparticle in accordance with one or more embodiments of the invention at two different states of electrochemical charge.

FIG. 4 is a cross-sectional representation of a nanoparticle in accordance with one or more embodiments of the invention at three different states of electrochemical charge.

FIG. 5 is a pictorial representation and flow chart showing a method of fabricating a nanostructured material according to one or more embodiments of the invention.

FIG. 6a is a pictorial representation and flow chart showing an alternate method of fabricating a nanostructured material according to one or more embodiments of the invention.

FIG. 6b is a pictorial representation and flow chart showing an alternate method of fabricating a nanostructured material according to one or more embodiments of the invention.

FIG. 7 is a pictorial representation and flow chart showing another alternate method of fabricating a nanostructured material according to one or more embodiments of the invention.

FIG. 8 is a pictorial representation of a cross section of an electrochemical cell according to one or more embodiments of the invention.

FIG. 9 is a pictorial representation of a cylindrical battery embodying concepts of the invention.

### DETAILED DESCRIPTION

Generally, the present disclosure is directed to novel nanostructured materials for use in energy storage devices and related methods for fabricating and using such materials.

One of the most promising technologies developed for controlling sulfide migration out of the cathode has been the design of nanostructures to contain electroactive sulfur in the cathode, for example by constructing nanoparticles with core-shell and yolk-shell structures. Such particles mitigate sulfide shuttling between the cathode and anode by physically containing electroactive sulfur inside of an impermeable shell. Yolk-shell structures comprise a hollow shell with an inner core, surrounded by a void space. The use of these nanostructured materials however presents new challenges with respect to providing sufficient flow of electrons and ions through the shell to allow conversion of the electroactive sulfur within.

In certain embodiments, provided nanostructured materials comprise yolk-shell structures. In some such embodiments, a liquid is contained in the void space of the yolk-shell structure. In certain embodiments, provided nanostructured materials comprise structures that are permeable. In some such embodiments, flow of solvent, salts, and additives across the permeable structure is afforded through changes in hydrostatic pressure, temperature, potential, and concentration gradient.

In certain embodiments, provided nanostructured materials comprise structures that are selectively permeable. In some such embodiments, the selectively permeable structure allows exchange of certain solvents, salts, and additives. The selective permeability characteristics of the provided nanostructured materials provide a means to improve the performance of electrochemical devices and, in particular, alkali metal sulfur batteries (e.g. lithium/sulfur or sodium/sulfur batteries) by enabling different liquid phase compositions to be present at different points in a battery (e.g. at the anode and cathode of the battery). Such materials can enable independent optimization of solvents, salts and additives at the cathode and anode of an electrochemical cell while maintaining ionic and electronic conduction between them.

### I. COMPOSITIONS

In one aspect, the invention provides compositions comprising nanostructured materials that encompass a contained volume that is isolated from the volume outside of the nanostructured material by a permeable structure (e.g., a membrane). In certain embodiments, a permeable structure comprises: an inner surface in contact with the contained volume, an outer surface in contact with a volume outside of the nanostructured material, wherein the exchange of liquids and/or solutes across the permeable structure is modulated through changes in conditions including hydrostatic pressure, temperature, potential, and concentration gradient.

In one aspect, the invention provides compositions comprising nanostructured materials that encompass a contained volume that is isolated from the volume outside of the nanostructured material by a selectively permeable structure. In certain embodiments, the selectively permeable structure comprises: an inner surface in contact with the contained volume, an outer surface in contact with a volume outside of the nanostructured material, and a thickness comprising a composition that has differential permeability to different liquids and/or solutes based on their molecular characteristics. In certain embodiments, the nanostructured material comprises a contained a liquid phase situated within the contained volume and in contact with the inner surface of the selectively permeable structure.

Molecules to which the selectively permeable structure is highly permeable thereby have the ability to exchange between the contained liquid phase and a liquid phase that is external to the nanostructured material, while molecules to which the selectively permeable structure has little or no permeability will be substantially unable to exchange between the contained and external liquid phases.

### A. Nanostructures

Before describing the specific characteristics of the provided permeable and selectively permeable nanostructured materials and their modes of operation, this section will describe general characteristics of nanostructures encompassed by the inventive concepts herein (e.g. the shape, size, and the arrangement of the components within the nanostructured materials).

Nanostructured materials of the present invention are not limited to any specific morphology. In certain embodiments, the inventive nanostructures have a morphology that defines a contained interior volume that is physically isolated from the space outside of the nanostructured material. In certain embodiments, the interior volume of the nanostructure is separated from an exterior space by a permeable structure. In certain embodiments, the interior volume of the nanostructure is separated from an exterior space by a selectively permeable structure. Nanostructured materials having such characteristics may take various morphological forms and the invention places no particular limitations on the morphology of the nanostructured materials. Non-limiting examples of nanostructured materials that may be fashioned with an interior volume separated from the exterior volume include: core shell particles, nanowires, nanostructured porous materials, closed-cell nanoporous foams, encapsulated nanocomposites, and related structures.

In certain embodiments, provided nanostructures comprise core-shell nanoparticles. Such nanoparticles comprise a substantially continuous shell that contains an internal volume and separates that volume from the space outside of the shell. In certain embodiments, such core shell particles are substantially spherical, though other geometries are also possible including: oblong or ovoid shapes, cylinders, prismatic shapes, irregular shapes, and polyhedral shapes. The optimal shape of nanoparticles may vary for different applications—while the descriptions and examples below concentrate on spherical core shell nanoparticles as a way of demonstrating the broader principles of the invention, it is to be understood that these principles apply to nanostructured materials with other morphologies and that such alternatives are contemplated within the scope of certain embodiments of the invention. Control of nanoparticle morphology is well understood in the art (e.g. using techniques such as templating, surfactant control, mechanical processing, and the like) and it is therefore within the ability of the skilled person to adapt the concepts described herein with respect to spherical core shell particles to other nanostructured materials.

Generally, the optimal dimensions of the nanostructures may vary to suit a particular application. In various embodiments, the nanostructure is a nanoparticle (e.g. a material comprising discrete nanoscale particles). In certain embodiments, such nanoparticles have at least one dimension in the range of about 10 to about 1000 nm. In some embodiments, the nanostructured material does not comprise nanoscale particles per se but has nanoscale features, as for example in nanoporous or mesoporous solids which may be present as larger particles, monoliths, or composites which may be formed with nanoscale features or constituents.

In certain embodiments, the provided nanostructures comprise substantially spherical nanoparticles with a diameter in the range of about 10 to about 5000 nm. In certain embodiments, the diameter of such spherical particles is, on average, less than about 100 nm—for example, provided nanoparticles may have diameters of 10 to 40 nm; 25 to 50 nm; or 50 to 100 nm. In certain embodiments, provided nanoparticles comprise spherical particles with a diameter less than about 500 nm—for example, provided nanoparticles may have diameters of 75 to 150 nm; 100 to 200 nm; 150 to 300 nm; 200 to 500 nm; or 300 to 500 nm. In certain embodiments, provided nanoparticles comprise spherical particles with a diameter less than about 1000 nm—for example, provided nanoparticles may have diameters of 200 to 600 nm; 500 to 800 nm; 600 to 800 nm; or 750 to 1000 nm. In certain embodiments, provided nanoparticles comprise spherical particles with a diameter between about 300 and 800 nm. In certain embodiments, provided nanoparticles comprise spherical particles with a diameter less than about 2000 nm—for example, provided nanoparticles may have diameters of 1000 to 1200 nm; 1000 to 1500 nm; 1300 to 1800; or 1500 to 2000 nm. In certain embodiments, provided nanoparticles comprise spherical particles with a diameter less than about 5000 nm—for example, provided nanoparticles may have diameters of 1000 to 2000 nm; 2000 to 3000 nm; 2500 to 3500 nm; 2000 to 4000 nm; or 3000 to 5000 nm.

In certain embodiments, the provided nanoparticles comprise cylindrical particles with a cross-sectional diameter in the range of about 10 to about 1000 nm. In certain embodiments, the cross-sectional diameter of such nanoparticles is less than about 100 nm—for example, provided cylindrical particles may have diameters of 10 to 40 nm; 25 to 50 nm; or 50 to 100 nm. In certain embodiments, the provided cylindrical particles have a cross-sectional diameter less than about 500 nm—for example, provided cylindrical particles may have diameters of 75 to 150 nm; 100 to 200 nm; 150 to 300 nm; 200 to 500 nm; or 300 to 500 nm. In certain embodiments, the provided nanoparticles comprise cylinders with a cross-sectional diameter less than about 1000 nm—for example, provided nanoparticles may have diameters of 200 to 600 nm; 500 to 800 nm; 600 to 800 nm; or 750 to 1000 nm. In certain embodiments, the provided nanoparticles comprise cylindrical particles with a diameter between about 100 and 400 nm. In certain embodiments, provided cylindrical particles have lengths greater than 1 μm. In certain embodiments, provided cylindrical nanoparticles have lengths greater than 5 μm, greater than 10 μm, greater than 20 μm, or greater than 50 μm. In certain embodiments, provided cylindrical nanoparticles have lengths of about 1 μm to about 1 cm. In certain embodiments, provided cylindrical nanoparticles have lengths of about 5 μm to about 1 cm. In certain embodiments, provided cylindrical nanoparticles have lengths of about 10 μm to about 1 cm. In certain embodiments, provided cylindrical nanoparticles have lengths of about 20 μm to about 1 cm. In certain embodiments, provided cylindrical nanoparticles have lengths of about 50 μm to about 1 cm. In certain embodiments, provided cylindrical nanoparticles have lengths of about 1 μm to about 1 mm. In certain embodiments, provided cylindrical nanoparticles have lengths of about 5 μm to about 1 mm. In certain embodiments, provided cylindrical nanoparticles have lengths of about 10 μm to about 1 mm. In certain embodiments, provided cylindrical nanoparticles have lengths of about 20 μm to about 1 mm. In certain embodiments, provided cylindrical nanoparticles have lengths of about 50 μm to about 1 mm. In certain embodiments, provided cylindrical nanoparticles have lengths of about 1 μm to about 100 μm. In certain embodiments, provided cylindrical nanoparticles have lengths of about 5 μm to about 100 μm. In certain embodiments, provided cylindrical nanoparticles have lengths of about 10 μm to about 100 μm. In certain embodiments, provided cylindrical nanoparticles have lengths of about 20 μm to about 100 μm. In certain embodiments, provided cylindrical nanoparticles have lengths of about 50 μm to about 100 μm. In certain embodiments, provided nanoparticles have an aspect ratio greater than 3, greater than 5, greater than 10, greater than 20. In certain embodiments, provided nanoparticles have an aspect ratio greater than 50, greater than 100, greater than 200, greater than 500, or greater than 1000.

In certain embodiments where the provided nanoparticles comprise a structure which separates an internal volume contained within the nanoparticle from a volume outside the nanoparticle (e.g. a shell or wall), such a structure may have a thickness of between about 0.5 and about 100 nm. The optimal thickness of such a structure will vary depending on the material from which it is made, the dimensions of the nanostructure of which it is a part, and/or the specific application for which the nanoparticle is being engineered. In certain embodiments, provided nanoparticles have a shell or wall thickness less than about 15 nm—for example, having a thickness in the range of about 1 to about 2 nm; about 2 to about 5 nm; about 5 to about 7 nm; about 5 to about 10 nm; or about 10 to about 15 nm. In certain embodiments, provided nanoparticles have a shell or wall thickness less than about 25 nm. In certain embodiments, provided nanoparticles have a shell or wall thickness less than about 50 nm—for example, having a thickness in the range of about 5 to about 15 nm; about 10 to about 20 nm; about 15 to about 30 nm; about 25 to about 40 nm; or about 30 to about 50 nm. In certain embodiments, provided nanoparticles have a shell or wall thickness less than about 75 nm. In certain embodiments, provided nanoparticles have a shell or wall thickness less than about 100 nm—for example, having a thickness in the range of about 50 to about 60 nm; about 50 to about 75 nm; about 60 to about 80 nm; or about 75 to about 100 nm.

It will be appreciated that a given combination of the particle shape, particle dimensions and wall thickness will together determine the size of the internal volumes enclosed within the particle (the ‘enclosed volume’). The shape of the enclosed volume may therefore be dictated by the morphology of the nanostructured material. In various embodiments, the enclosed volume may comprise a single chamber, or it may comprise a plurality of smaller spaces that are isolated from each other or that have varying degrees of interconnectedness.

### B. Permeable Structures

As described above, certain nanostructured materials of the present invention are characterized in that they enclose a contained volume that is separated from a volume outside the nanostructured material by a permeable structure. In certain embodiments, the structure with permeability comprises a membrane separating the contained volume from the external volume and for convenience, the permeable structure may be referred to simply as a “permeable membrane” herein.

Permeability refers to the property of allowing the movement of molecules across a structure (or membrane). The exchange of liquids and/or solutes across the permeable membrane is controlled through changes in conditions including hydrostatic pressure, temperature, potential, and concentration gradient. For example, in certain embodiments, liquids and/or solutes will exchange across a permeable membrane from areas of high concentration to low concentration. For example, in certain embodiments, liquids and/or solutes will exchange across a permeable membrane from areas of high hydrostatic pressure to areas of low hydrostatic pressure.

In certain embodiments, provided nanostructured materials comprise permeable membranes that are nanoporous. In certain embodiments, permeable structures have pore sizes less than 5 nm; for example, less than 4 nm, less than 3 nm, less than 2 nm, or less than 1.5 nm. In certain embodiments, permeable structures have pore sizes less than 1 nm; for example, less than 0.9 nm, less than 0.8 nm, less than 0.7 nm, or less than 0.6 nm. In certain embodiments, permeable structures have pore sizes less than 0.5 nm; for example, less than 0.4 nm, less than 0.3 nm, less than 0.25 nm, less than 0.2 nm, less than 0.15 or less than 0.10 nm. In certain embodiments, permeable structures have pore sizes between about 1 and about 5 nm. In certain embodiments, permeable structures have pore sizes between about 1 and about 2 nm. In certain embodiments, permeable structures have pore sizes between about 0.5 and about 1.5 nm. In certain embodiments, permeable structures have pore sizes between about 0.1 and about 1 nm. In certain embodiments, permeable structures have pore sizes between about 0.5 and about 1 nm. In certain embodiments, permeable structures have pore sizes between about 0.1 and about 0.5 nm. In certain embodiments, the pore size is measured by microscopy (e.g. TEM, SEM, or AFM).

The present invention places no particular restriction on the composition of permeable structures described herein. Particularly useful aspects of the compositions include suitable permeability characteristics as described above as well as physical and chemical compatibility with the electrolytes, active species, additives and solutes that will be encountered in the electrochemical devices to which the nanostructured materials are to be applied. In certain embodiments, a permeable structure comprises a polymer. In certain embodiments, a permeable structure comprises an inorganic solid. In certain embodiments, a permeable structure comprises a composite of a polymer and an inorganic solid.

In certain embodiments, a permeable structure comprises a polymer composition wherein the polymer is selected from the group consisting of polyolefins, polyesters, polyamides, polyimides, polyheterocycles, and polyketones. In certain embodiments, a permeable structure comprises a polymer composition wherein the polymer is selected from the group consisting of: polyethylene, polypropylene, polytetrafluoroethylene (PTFE), polyvinylidene difluoride (PVDF), polysulfone, polyethersulfone, polyacrylonitrile, polyamide, polyimide, polyamideimide, polyetherimide, cellulose acetate, polyaniline, polypyrrole, polyetheretherketone (PEEK), polybenzimidazole, and composites or mixtures thereof. A permeable structure comprising such polymers can be made by any technique known in the art, including in situ polymerization, solution coating, sintering, stretching, track etching, template leaching, interfacial polymerization, or phase inversion.

In another embodiment, a permeable structure comprises an inorganic material such as, for example, a ceramic, a metal oxide, a metal sulfide, or a clay. In certain embodiments, a permeable structure comprises an inorganic material selected from the group consisting of: silicon carbide, silicon oxide, iron oxide, manganese oxide, titanium disulfide, molybdenum disulfide, zirconium oxide, titanium oxide, and zeolites.

In another embodiment, a permeable structure comprises a polymer with dispersed organic or inorganic matrices in the form of nano-sized powdered solids present at amounts up to 20 wt % of a polymer membrane. Carbon matrices can be prepared by pyrolysis of any suitable material as described in U.S. Pat. No. 6,585,802. Zeolites as described in U.S. Pat. No. 6,755,900 may also be used as an inorganic matrix. In at least one embodiment, matrices are particles less than about 50 nanometers diameter, for example less than about 40 nm, less than about 25 nm, less than about 20 nm, less than about 10 nm, less than about 5 nm, less than about 2 nm, or less than 1 nm in diameter.

In certain embodiments, a permeable structure comprises a plurality of polymer layers. In certain embodiments, a permeable structure comprises two polymer layers. In certain embodiments, a permeable structure comprises three polymer layers.

In certain embodiments, permeable structures of the present invention comprise electronically conductive polymers. In certain embodiments, permeable structures of the present invention comprise polymers selected from the group consisting of: polyaniline, polydopamine, polypyrrole, polyselenophene, polythiophene, polynaphthalene, polyphenylene sulfide, and derivatives, mixtures or copolymers of any of these. In certain embodiments, permeable structures of the present invention comprise polymers selected from the group consisting of: polypyrrole (PPy), polythiophene (PTh), polydopamine, poly(3,4-ethylenedioxythiophene) (PEDOT), poly(3,4-propylenedioxythiophene) (ProDOT), poly(3,4-ethylenedioxypyrrole) (PEDOP), poly(3,4-propylenedioxypyrrole) (ProDOP), poly(3,4-ethylenedithiopyrrole) (PEDTP), poly(3,4-ethyleneoxyhiathiophene) (PEOTT), poly(3,4-ethylenedioxyselenophene) (PEDOSe), and derivatives, mixtures or copolymers of any of these. In certain embodiments, permeable structures of the present invention comprise polymers selected from the group consisting of: polyaniline (PAni), poly(o-methylaniline) (POTO), poly(o-methoxyaniline) (POAS), poly(2,5-dimethylaniline) (PDMA), poly(2,5-dimethoxyaniline) (PDOA), sulfonated polyaniline (SPAN), poly(l-aminonaphthalene) (PNA), poly(5-aminonaphthalene-2-sulfonic acid) polyphenylene sulfide, and derivatives, mixtures or copolymers of any of these.

### C. Selectively Permeable Structures

### Composition and Properties of the Selectively Permeable Structures

As described above, certain nanostructured materials of the present invention are characterized in that they enclose a contained volume that is separated from a volume outside the nanostructured material by a selectively permeable structure. In certain embodiments, the structure with selective permeability comprises a membrane separating the contained volume from the external volume and for convenience, the selectively permeable structure may be referred to simply as a “selectively permeable membrane” herein.

Selective permeability refers to the property of preferentially allowing or preventing permeation of molecules based on differences in their properties. In certain embodiments, the selectively permeable structures have selectivity based on molecular size, polarity, charge, or combinations of these features. In certain embodiments, selectively permeable structures are size selective—e.g. the structure selectively retains or permeates molecules based on differences in their molecular weights or molecular volumes. In certain embodiments, selectively permeable structures have selectivity based on the charges of molecules—e.g. the structure selectively retains or permeates molecules based on differences in their overall charges or their charge-to-mass or charge-to-size ratios.

In certain embodiments, a selectively permeable structure is characterized in that it selectively retains or permeates molecules based on their sizes. In certain embodiments, the permeability of a selectively permeable structure is defined by its molecular weight cutoff (MWCO) value. The MWCO is expressed in Daltons (Da) and is defined as the lowest molecular weight at which at least 90% of a component in a mixture in contact with the structure will be prevented from permeating through the structure. The MWCO of the selectively permeable structure in the provided nanostructured materials can be measured directly in the nanostructured material or indirectly inferred by reference to the MWCO values published for the material from which the selectively permeable structure is composed (i.e. published values). Where the permeability is measured, this may be done experimentally, for example by performing experiments immersing the nanostructured material in a liquid containing test components with various specific molecular weights and measuring the ability of the components to diffuse into the contained liquid phase enclosed by the nanostructured material. Such measurements can also be performed on samples of the selectively permeable composition that are not incorporated into the nanostructured material—for example, by testing the MWCO of a film of the material from which the selectively permeable structure in the provided nanostructured material is composed.

In certain embodiments, provided nanostructured materials comprise selectively permeable structures characterized in that they have a MWCO less than 1000 Da. In certain embodiments, selectively permeable structures are characterized in that they have a MWCO less than 800 Da, less than 600 Da, less than 500 Da, less than 400 Da, less than 300 Da, or less than 200 Da. In certain embodiments, selectively permeable structures are characterized in that they have a MWCO around 150 Da. In certain embodiments, selectively permeable structures are characterized in that they have a MWCO around 200 Da. In certain embodiments, selectively permeable structures are characterized in that they have a MWCO around 250 Da. In certain embodiments, selectively permeable structures are characterized in that they have a MWCO around 300 Da. In certain embodiments, selectively permeable structures are characterized in that they have a MWCO between about 150 and about 250 Da. In certain embodiments, selectively permeable structures are characterized in that they have a MWCO between about 200 and about 300 Da. In certain embodiments, selectively permeable structures are characterized in that they have a MWCO between about 300 and about 400 Da. In certain embodiments, selectively permeable structures are characterized in that they have a MWCO between about 250 and about 500 Da. In certain embodiments, the MWCO refers to a value determined in a liquid composition corresponding to an electrolyte to which the nanostructured material will be exposed in its intended application in an electrochemical device.

In certain embodiments, a selectively permeable structure is a porous membrane. In certain embodiments, the selective permeability properties of the structure are determined by the physical dimensions of pores in the membrane. In certain embodiments, the porosity and related characteristics such as the pore size and pore size distribution of the selectively permeable membrane can be determined by performing measurements on the nanostructured material (e.g. by scanning electron microscopy (SEM), by tunneling electron microscopy (TEM), or atomic force microscopy (AFM)). Alternatively, techniques known in the art such as gas absorption desorption isotherm measurements, evaporporometry, permporometry, mercury porosimetry, thermoporometry, bubble point measurement, and liquid displacement techniques can be utilized to measure the porosity and pore characteristics of the selectively permeable structures. Measurements can be performed directly on the nanostructured material or, if this is not feasible, can be performed on samples of the selectively permeable composition that are not incorporated into the nanostructured material—for example by measuring the porosity of films of the material composing the selectively permeable structure in the provided nanostructured material. The porosity of the structure can also be inferred from published values for the porosity of the same material in other contexts.

In certain embodiments, provided nanostructured materials comprising selectively permeable membranes are nanoporous. In certain embodiments, the selectively permeable structures have pore sizes less than 5 nm; for example, less than 4 nm, less than 3 nm, less than 2 nm, or less than 1.5 nm. In certain embodiments, the selectively permeable structures have pore sizes less than 1 nm; for example, less than 0.9 nm, less than 0.8 nm, less than 0.7 nm, or less than 0.6 nm. In certain embodiments, the selectively permeable structures have pore sizes less than 0.5 nm; for example, less than 0.4 nm, less than 0.3 nm, less than 0.25 nm, less than 0.2 nm, less than 0.15 or less than 0.10 nm. In certain embodiments, the selectively permeable structures have pore sizes between about 1 and about 5 nm. In certain embodiments, the selectively permeable structures have pore sizes between about 1 and about 2 nm. In certain embodiments, the selectively permeable structures have pore sizes between about 0.5 and about 1.5 nm. In certain embodiments, the selectively permeable structures have pore sizes between about 0.1 and about 1 nm. In certain embodiments, the selectively permeable structures have pore sizes between about 0.5 and about 1 nm. In certain embodiments, the selectively permeable structures have pore sizes between about 0.1 and about 0.5 nm. In certain embodiments, the pore size is measured by microscopy (e.g. TEM, SEM, or AFM).

In certain embodiments where the selectively permeable structure comprises a nanoporous material, the material is characterized in that it has a narrow distribution of pore sizes. In certain embodiments, provided nanostructured materials comprise selectively permeable membranes wherein at least 80% of the pores have a diameter within +/−20% of the mean pore diameter. In certain embodiments, provided nanostructured materials comprise selectively permeable membranes wherein at least 90% of the pores have a diameter within +/−20% of the mean pore diameter. In certain embodiments, provided nanostructured materials comprise selectively permeable membranes wherein at least 90% of the pores have a diameter within +/−15% of the mean pore diameter. In certain embodiments, provided nanostructured materials comprise selectively permeable membranes wherein at least 90% of the pores have a diameter within +/−10% of the mean pore diameter. In certain embodiments, the pore size distribution is measured by microscopy (e.g. TEM, SEM, or AFM).

In certain embodiments, the selectively permeable structures have selectivity based on the charges of molecules—e.g. the structure selectively retains or permeates molecules based on differences in their overall charges, their charge-to-mass ratios, or their charge-to-size ratios. In certain embodiments, the provided structures permeate lithium cations. In certain embodiments, the selectively permeable structure has high permeability to cations, but low permeability to anions. In certain embodiments, the selectively permeable structure has high permeability to lithium ions and mono-anions, but low permeability to di-anions. In certain embodiments, the selectively permeable structure has high permeability to lithium ions, but low permeability to di-anions.

The present invention places no particular restriction on the composition of the selectively permeable structures described above. Particularly useful aspects of the compositions include suitable permeability characteristics as described above as well as physical and chemical compatibility with the electrolytes, active species, additives and solutes that will be encountered in the electrochemical devices to which the nanostructured materials are to be applied. In certain embodiments, the selectively permeable structure comprises a polymer. In certain embodiments, the selectively permeable structure comprises an inorganic solid. In certain embodiments, the selectively permeable structure comprises a composite of a polymer and an inorganic solid.

In certain embodiments, the selectively permeable structure comprises a polymer composition with nanofiltration properties wherein the polymer is selected from the group consisting of: polyethylene, polypropylene, polytetrafluoroethylene (PTFE), polyvinylidene difluoride (PVDF), polysulfone, polyethersulfone, polyacrylonitrile, polyamide, polyimide, polyamideimide, polyetherimide, cellulose acetate, polyaniline, polypyrrole, polyetheretherketone (PEEK), polybenzimidazole, and composites or mixtures thereof. The selectively permeable structure comprising such polymers can be made by any technique known in the art, including in situ polymerization, solution coating, sintering, stretching, track etching, template leaching, interfacial polymerization, or phase inversion.

In some embodiments, the selectively permeable structure may comprise polymers that are crosslinked or treated so as to improve their stability. By way of non-limiting example, a selectively permeable structure may comprise membranes described in GB2437519, the contents of which are incorporated herein by reference.

In certain embodiments, the selectively permeable structure comprises a composite material having a macroporous support layer and a non-porous or nanoporous selectively permeable layer. The thin, non-porous, selectively permeable layer may, for example, be formed from or comprise a material chosen from modified polysiloxane based elastomers including polydimethylsiloxane (PDMS) based elastomers, ethylene-propylene diene (EPDM) based elastomers, polynorbornene based elastomers, polyoctenamer based elastomers, polyurethane based elastomers, butadiene and nitrile butadiene rubber based elastomers, natural rubber, butyl rubber based elastomers, polychloroprene (Neoprene) based elastomers, epichlorohydrin elastomers, polyacrylate elastomers, polyethylene, polypropylene, polytetrafluoroethylene (PTFE), polyvinylidene difluoride (PVDF) based elastomers, polyetherblock amides (PEBAX), polyurethane elastomers, crosslinked polyether, polyamide, polyaniline, polypyrrole, and mixtures thereof.

In another embodiment, the selectively permeable structure comprises an inorganic material such as, for example, a metal oxide, metal sulfide, ceramic or clay. In certain embodiments, the selectively permeable structure comprises an inorganic material selected from: silicon carbide, silicon oxide, iron oxide, manganese oxide, titanium disulfide, molybdenum disulfide, zirconium oxide, titanium oxide, and zeolites.

In another embodiment, the selectively permeable structure comprises a polymer with dispersed organic or inorganic matrices in the form of nano-sized powdered solids. In certain embodiments, such dispersed materials are present at amounts up to 20 wt % of the polymer membrane. Carbon matrices can be prepared by pyrolysis of any suitable material as described in U.S. Pat. No. 6,585,802. Zeolites as described in U.S. Pat. No. 6,755,900 may also be used as an inorganic matrix. In at least one embodiment, the matrices will be particles less than about 50 nanometers diameter, for example, less than about 40 nm, less than about 25 nm, less than about 20 nm, less than about 10 nm, less than about 5 nm, less than about 2 nm, or less than 1 nm in diameter.

In certain embodiments, the selectively permeable structure comprises a plurality of polymer layers. In certain embodiments, the selectively permeable structure comprises two polymer layers. In certain embodiments, the selectively permeable structure comprises three polymer layers. In certain embodiments, the selectively permeable structure comprises more than three polymer layers.

In certain embodiments, the selectively permeable structure comprises a polymer-based membrane of the phase inversion type (e.g. produced from polyimide dope solutions) or a coated type (e.g. coated with rubber compounds such as silicone and derivatives) or thin-film composite type (e.g. with a separating layer generated via interfacial polymerization).

In certain embodiments, selectively permeable structures of the present invention comprise polyimide membranes. In certain embodiments, selectively permeable structures of the present invention comprise P84 (CAS No. 9046-51-9) and P84HT (CAS No. 134119-41-8) and/or blends thereof and/or blends comprising one or both of said polyimides. In preferred embodiments, the polyimide membranes are crosslinked according to GB2437519. In certain embodiments, selectively permeable structures of the present invention comprise crosslinked or non-crosslinked, coated polyimide membranes, especially made of P84 and/P84HT and/or mixtures thereof, wherein the coating comprises silicone acrylates. Particular preferred silicone acrylates to coat the membranes are described in U.S. Pat. Nos. 6,368,382, 5,733,663, JP 62-136212, JP 59-225705, DE 102009047351 and EP 1741481 A1.

In certain embodiments, selectively permeable structures of the present invention comprise electronically conductive polymers. In certain embodiments, selectively permeable structures of the present invention comprise polymers selected from the group consisting of: polyaniline, polypyrrole, polythiophene, polyphenylene sulfide, and derivatives, mixtures or copolymers of any of these. In certain embodiments, selectively permeable structures of the present invention comprise polymers selected from the group consisting of: polypyrrole (PPy), polythiophene (PTh), polydopamine, poly(3,4-ethylenedioxythiophene) (PEDOT), poly(3,4-propylenedioxythiophene) (ProDOT), poly(3,4-ethylenedioxypyrrole) (PEDOP), poly(3,4-propylenedioxypyrrole) (ProDOP), poly(3,4-ethylenedithiopyrrole) (PEDTP), poly(3,4-ethyleneoxyhiathiophene) (PEOTT), poly(3,4-ethylenedioxyselenophene) (PEDOSe) and derivatives, mixtures or copolymers of any of these. In certain embodiments, selectively permeable structures of the present invention comprise polymers selected from the group consisting of: polyaniline (PAni), poly(o-methylaniline) (POTO), poly(o-methoxyaniline) (POAS), poly(2,5-dimethylaniline) (PDMA), poly(2,5-dimethoxyaniline) (PDOA), sulfonated polyaniline (SPANi), poly(l-aminonaphthalene) (PNA), poly(5-aminonaphthalene-2-sulfonic acid) polyphenylene sulfide, and derivatives, mixtures or copolymers of any of these. In certain embodiments, selectively permeable structures of the present invention comprise cross-linked conductive polymer compositions. In certain embodiments, such cross-linked conductive polymer compositions comprise any of the above conductive polymers that have been thermally or chemically crosslinked. In certain embodiments, such crosslinked conductive polymer compositions comprise any of the above conductive polymers crosslinked by vulcanization.

In certain embodiments, selectively permeable structures of the present invention comprise cross-linked polymer membranes that are stable to ethereal solvents. In certain embodiments, the cross-linked polymer membranes are stable to solvents selected from the group consisting of: dimethoxyethane, glyme, diglyme, triglyme, tetraglyme, higher glymes, polyethers, trimethoxymethane, dimethoxyethane, diethoxyethane, 1,2-dimethoxypropane, ethylene glycol divinylether, diethylene glycol divinylether, triethylene glycol divinylether, dipropylene glycol dimethyl ether, butylene glycol ethers, 1,3-dimethoxypropane, 1,3 dioxolane, 1,4 dioxane, 1,3 dioxane, trioxane, tetrahydrofuran, furan, dihydrofuran, 2-methyltetrahydrofuran, tetrahydropyran, pyran, dihydropyran, diethyl ether, dipropyl ether, dibutyl ether, dimethoxymethane, t-butylmethyl ether, diphenyl ether, phenylmethyl ether, and mixtures of any two or more of these. In certain embodiments, the cross-linked polymer membranes are stable to solvents selected from the group consisting of: dimethoxyethane, 1,2-dimethoxypropane, 1,3 dioxolane, 1,4 dioxane, 1,3 dioxane, trioxane, tetrahydrofuran, furan, and mixtures of any two or more of these. In certain embodiments, the cross-linked membranes are stable to solvents selected from the group consisting of: dimethoxyethane, 1,2-dimethoxypropane, 1,3 dioxolane, and mixtures of these.

In certain embodiments, selectively permeable structures of the present invention comprise cross-linked polymer membranes that are stable to sulfone solvents. In certain embodiments, the cross-linked membranes are stable to solvents selected from the group consisting of: sulfolane, 3-methyl sulfolane, 3-sulfolene, diethyl sulfone, dimethyl sulfone, methylethyl sulfone, and mixtures of two or more of these. In certain embodiments, the cross-linked membranes are stable to solvents selected from the group consisting of: sulfolane, 3-methyl sulfolane, and 3-sulfolene, and mixtures of two or more of these.

In certain embodiments, where the selectively permeable structures of the present invention comprise cross-linked polymer membranes that are stable to solvents, this means that a membrane does not appreciably dissolve in the solvent. In certain embodiments, the membrane does not swell by more than 50% when immersed in the solvent. In certain embodiments, the membrane does not swell by more than 40%, more than 30%, more than 25%, more than 20%, more than 15%, or more than 10% when immersed in the solvent.

Generally, the permeability or inverse barrier is an important physical property for many industrial applications of polymers. For example, there are numerous applications for polymers with low, high or tailored (i.e., selective) permeability, such as protective coatings or barriers to control the flow of certain substances there through. Generally, the transport of substances through polymer barriers (e.g., polymeric shells) is caused by either a pressure or temperature gradient, or by an external force field and/or a concentration gradient. The permeability of a substance through the shell can be very different for different polymers and permeants. In general, permeability and solubility of polymers at a given temperature depend on the degree of crystallinity (morphology), the molecular weight, the type of permeant and its concentration or pressure, and in the case of copolymers, also on the composition.

Accordingly, by tailoring the permeability of the selectively permeable structure, it is possible to control which substances are allowed to enter the interior volume of the nanostructured material, or not, and which substances are allowed to exit the interior volume, or not. There are several means for tailoring the permeability of the polymeric structure that are described herein. Generally, the selective permeability of the structure is determined by the presence, size, morphology (e.g., void shapes), and distribution of pores within the polymer, which can be controlled by, for example, acid doping, dedoping and redoping, cross-linking, the introduction of certain additives, or combinations thereof during the polymerization process, or in some cases as part of a post-polymerization process.

Various examples of acid doping, chemical and thermal cross-linking, and the use of certain additives are disclosed in “Polyaniline Membranes for Use in Organic Solvent Nanofiltration” by Xun Xing Loh, Dept. of Chemical Engineering and Chemical Technology Imperial College of London, April 2009; and PCT Publication Nos. WO2017/091645 and WO2018/049013, the entire disclosures of which are incorporated by reference herein. Exemplary description of acid doping and cross-linking are also described infra.

In certain embodiments, the selectively permeable structures are characterized in that they have high permeability to the organic solvents comprising an electrolyte in an electrochemical cell in which the nanostructured material is to be utilized. In certain embodiments, the selectively permeable structures are characterized in that they have high permeability to dimethoxyethane (DME) and 1,3-dioxolane (DOL). In certain embodiments, the selectively permeable structures are characterized in that they have high permeability to sulfolane, sulfolene, dimethyl sulfone, or methyl ethyl sulfone. In certain embodiments, the selectively permeable structures are characterized in that they have high permeability to ethylene carbonate, propylene carbonate, dimethyl carbonate, diethyl carbonate, and methylethyl carbonate.

In certain embodiments, the flux of the solvent through the selectively permeable structure is at least 1×10⁻⁶ l·m⁻²·h⁻¹ bar⁻¹. In certain embodiments, the flux of the solvent through the selectively permeable structure is at least 1×10⁻⁶ l·m⁻²·h⁻¹ bar⁻¹. In certain embodiments, the flux of the solvent through the selectively permeable structure is at least 5×10⁻⁶, 1×10⁻⁵, 5×10⁻⁵, 1×10⁻⁴, 5×10⁻⁴, 1×10⁻³, or 1×10⁻² l·m⁻²·h⁻¹ bar⁻¹. In certain embodiments, the flux of the solvent through the selectively permeable structure is between 1×10⁻⁶ l·m⁻²·h⁻¹ bar⁻¹ and 100 l·m⁻²·h⁻¹ bar⁻¹. In certain embodiments, where the selectively permeable structures are characterized in that they have high permeability to the organic solvents, this means that the flux of the solvent through the structure is at least 0.005, at least 0.01, at least 0.05, at least 0.1, at least 0.5, or at least 1 l·m⁻²·h⁻¹ bar⁻¹ (e.g., between 0.005 and 100 l·m⁻²·h⁻¹ bar⁻¹). The solvent flux of a selectively permeable structure may be measured directly on the nanostructured material (for example by subjecting the nanostructured material to the test solvent under a pressure differential and measuring how much of the test solvent enters the contained volume). Alternatively, the flux can be measured for a sample material from which the selectively permeable structure is constructed using methods known in the art.

In certain embodiments, the selectively permeable structures are characterized in that they have high permeability to lithium ions. In certain embodiments, the selectively permeable structures are characterized in that they have a lithium ion conductivity of at least 1×10⁻⁶ S cm⁻¹. In certain embodiments, the selectively permeable structures are characterized in that they have a lithium ion conductivity of at least 5×10⁻⁶, at least 1×10, at least 5×10⁻⁵, at least 1×10⁻⁴, or at least 5×10⁻⁴ S cm⁻¹ (e.g., between 5×10⁻⁶ and 5×10⁻¹ S cm⁻¹. In certain embodiments, the selectively permeable structures are characterized in that they have a lithium ion conductivity of at least 1 mS cm⁻¹. In certain embodiments, the selectively permeable structures are characterized in that they have a lithium ion conductivity of at least 2, at least 5, or at least 10 mS cm⁻¹.

### Physical Characteristics of the Selectively Permeable Structures

As described above, in certain embodiments the invention encompasses nanostructured materials wherein a volume enclosed within the nanostructure contains a liquid phase (a ‘contained liquid phase’), which is physically separated from the volume outside of the nanostructured material by the selectively permeable structure. Perhaps the simplest morphology for such a system are the core shell nanoparticles previously described. In certain embodiments, the selectively permeable structure comprises a substantially continuous shell of a core shell nanoparticle (e.g. a selectively permeable shell). In certain embodiments, the selectively permeable shell has an interior surface in contact with a contained liquid phase in the core of the nanoparticle and an exterior surface that is in contact with the volume outside of the nanoparticle.

In certain embodiments, the selectively permeable structure is present in a three dimensional form characterized in that one dimension (i.e. its thickness) is substantially smaller than the other two dimensions, examples of these include sheets, shells, coatings, and the like. In certain embodiments, such compositions are characterized in that they have a smallest dimension (e.g. thickness) less than 50 nm. In certain embodiments, the selectively permeable structure is present in a sheet-like form or a shell having a thickness between about 5 and about 10 nm, between about 5 and about 25 nm, between about 10 and about 40 nm, or between about 25 and about 50 nm.

In certain embodiments, the selectively permeable structure is a shell that has a thickness in the range of about 0.5 nm to about 100 nm. In certain embodiments, provided nanoparticles have a selectively permeable shell less than about 15 nm thick—for example, having a thickness in the range of about 1 to about 2 nm; about 2 to about 5 nm; about 5 to about 7 nm; about 5 to about 10 nm; or about 10 to about 15 nm. In certain embodiments, provided nanoparticles have a selectively permeable shell less than about 25 nm thick. In certain embodiments, provided nanoparticles have a selectively permeable shell less than about 50 nm thick—for example, having a thickness in the range of about 5 to about 15 nm; about 10 to about 20 nm; about 15 to about 30 nm; about 25 to about 40 nm; or about 30 to about 50 nm. In certain embodiments, provided nanoparticles have a selectively permeable shell less than about 75 nm thick. In certain embodiments, provided nanoparticles have a selectively permeable shell less than about 100 nm thick—for example, having a thickness in the range of about 50 to about 60 nm; about 50 to about 75 nm; about 60 to about 80 nm; or about 75 to about 100 nm.

In certain embodiments, the selectively permeable shell is characterized in that it is permeable to at least one constituent of an electrolyte composition of an electrochemical cell in which the nanoparticle will be utilized.

In certain embodiments, the selectively permeable shell is engineered with a surface area and permeability such that it can accommodate the volume expansion of an electroactive species present in the contained volume of the nanostructured material. For example, where the nanostructured material contains elemental sulfur as the contained electroactive material, a shell that is engineered with sufficient surface area and permeability is able to permit electrolyte to permeate out of the contained volume at a rate sufficient to accommodate the increasing volume of the electroactive sulfur as it is converted to lithium sulfide during discharge and thereby avoid damage to the nanostructured material—in the example of sulfur as the electroactive species in a lithium battery, the volume of the contained electroactive species increases to approximately 1.73× its original volume meaning a volume of electrolyte corresponding to 73% of the sulfur volume must permeate through the shell during complete discharge of the contained sulfur. If a cathode containing such a material is discharged at a rate of 1 C, this volume of electrolyte must permeate through the shell in one hour. Likewise at 2 C, the process must occur in ½ hour, at 3 C in 20 minutes and so on.

In certain embodiments, the selectively permeable shell has sufficient permeability to allow a volume of solvent equal to at least 50% of the contained volume to permeate through the shell in one hour during discharge of a contained electroactive sulfur composition. In certain embodiments, the selectively permeable shell has sufficient permeability to allow a volume of solvent equal to at least 50% of the contained volume to permeate through the shell in 30 minutes during discharge of a contained electroactive sulfur composition. In certain embodiments, the selectively permeable shell has sufficient permeability to allow a volume of solvent equal to at least 50% of the contained volume to permeate through the shell in 15 minutes, or in 10 minutes during discharge of a contained electroactive sulfur composition.

In any of these nanostructures, the portions of the structure comprising the selectively permeable structure (e.g. the shell, matrix, layer, etc.), may consist entirely of a permeable material, or may comprise the permeable material along with additional materials. Such additional materials may be present in various forms, for example: additional materials can be present as discrete layers contained within or disposed upon the selectively permeable structure (e.g. in a multilayer shell); the additional materials may be present as mixtures intimately mixed or compounded with a semipermeable material; or the additional materials may be present in composites with the semipermeable material. Suitable additional materials that may be present include polymers, elemental carbon, metallic elements or alloys, metal oxides, metal chalcogenides, metal salts, ceramics, glasses, clays, semiconductors, and the like.

### D. Contained Electroactive Substances

As described above, nanostructured materials of the present invention comprise electroactive substances that are contained within an enclosed volume that is separated from space outside of the nanostructured material by a selectively permeable structure. Such substances undergo electrochemical reactions and provide electrical capacity to devices fabricated from the provided nanostructured materials. These substances are referred to generically herein as ‘contained electroactive materials’. In certain embodiments, the provided nanostructured materials comprise solid electroactive materials which are contained within the enclosed volume and which are in contact with a contained liquid phase. In certain embodiments, the contained electroactive material may be a liquid or may be dissolved in a liquid phase.

In embodiments where the contained electroactive materials are solids, they may be referred to generically as ‘contained electroactive solids’. Such solids have a composition different from the solid substance(s) composing the structure of the nanostructured materials. No specific limitations are placed on the shape of such contained electroactive solids or their distribution within the enclosed volume. In certain embodiments, the contained electroactive solid is provided as a particle which is partially or wholly separated from the nanostructured material in which it is contained (i.e. as the yolk in a yolk shell nanoparticle). In certain embodiments, the contained electroactive substance is in physical contact or is wholly or partially adhered to the nanostructured material. In certain embodiments, the contained electroactive substance is present as a coating on an interior surface defining the contained volume in the nanostructured material. It is noteworthy that contained electroactive solids may be produced or manufactured with a particular shape or arrangement within the nanostructured material, but that these may change during the operation (e.g. charge or discharge) of an electrochemical device comprising the electroactive material.

The size and shape of a contained electroactive solid will also vary to suit a particular application and may have a diameter in the range of about 10 to about 2000 nm. Generally, the solid will occupy from about 20% to about 80% of the enclosed volume, with the contained liquid phase and/or other solid materials (e.g. conductive additives, etc.) occupying the remaining volume (e.g., about 80% to about 20%) depending on the charge/discharge status of an electrode or energy storage device containing the nanoparticles. In some embodiments, the solid will occupy from about 20% to about 70% of the enclosed volume. In some embodiments, the solid will occupy from about 20% to about 60% of the enclosed volume. In some embodiments, the solid will occupy from about 20% to about 50% of the enclosed volume. In some embodiments, the solid will occupy from about 20% to about 40% of the enclosed volume. In some embodiments, the solid will occupy from about 20% to about 30% of the enclosed volume. In some embodiments, the solid will occupy from about 30% to about 70% of the enclosed volume. In some embodiments, the solid will occupy from about 40% to about 60% of the enclosed volume. In some embodiments, the solid will occupy from about 45% to about 55% of the enclosed volume. In some embodiments, the solid will occupy from about 50% to about 60% of the enclosed volume. In some embodiments, the solid will occupy from about 50% to about 70% of the enclosed volume. In some embodiments, the solid will occupy from about 50% to about 80% of the enclosed volume. In some embodiments, the solid will occupy from about 60% to about 80% of the enclosed volume. In some embodiments, the solid will occupy from about 75% to about 80% of the enclosed volume.

In certain embodiments, the contained electroactive solid is present in a form having at least one dimension with a length in the range of about 5 to about 3,000 nm. In certain embodiments, the contained electroactive solid is present in a form having at least one dimension with a length in the range of about 10 to about 50 nm, about 30 to about 100 nm, about 100 to about 500 nm, or about 500 to about 1000 nm. In certain embodiments, the contained electroactive solid is present in a form having at least one dimension with a length in the range of about 1000 to about 1500 nm, about 1000 to about 2000 nm, about 1500 to about 3000 nm, or about 2000 to about 3000 nm.

In certain embodiments, the contained electroactive material comprises sulfur and the nanostructured materials have utility as cathode materials for sulfur batteries. Such compositions comprise an electroactive sulfur-based material. Examples of suitable electroactive sulfur materials include elemental sulfur; sulfur-containing organic molecules, sulfur-containing polymers or composites; or metal sulfides as well as combinations or composites of two or more of these.

In certain embodiments, the electroactive sulfur is present in the form of elemental sulfur. In certain embodiments, the electroactive sulfur material comprises Ss.

In certain embodiments, the electroactive sulfur is present as a metal sulfide. In certain embodiments, the metal sulfide comprises an alkali metal sulfide; in certain embodiments, the metal sulfide comprises lithium sulfide.

In certain embodiments, the electroactive sulfur material is present as a composite with another material. Such composites may include materials such as graphite, graphene, other carbon allotropes, metal sulfides or oxides, or conductive polymers. In certain embodiments, the sulfur may be alloyed with other chalcogenides such as selenium or arsenic.

Generally, the dimensions and shape of the electroactive sulfur-based material in the cathode composition may be varied to suit a particular application and/or be controlled as a result of the morphology of the nanostructure comprising the electroactive sulfur. In various embodiments, the electroactive sulfur-based material is present as a nanoparticle. In certain embodiments, such electroactive sulfur-based nanoparticles have a spherical or spheroid shape. In certain embodiments, nanostructured materials of the present invention comprise substantially spherical sulfur-containing particles with a diameter in the range of about 50 to about 1200 nm. In certain embodiments, such particles have a diameter in the range of about 50 to about 250 nm, about 100 to about 500 nm, about 200 to about 600 nm, about 400 to about 800 nm, or about 500 to about 1000 nm.

Such nanoparticles may have various morphologies as described above. In certain embodiments, the electroactive sulfur-based material is present as the core of a core-shell particle, where it is surrounded by a selectively permeable shell. In certain embodiments, such core-shell particles may comprise yolk-shell particles as described above.

E. Selectively Permeable Nanostructured Materials and their Modes of Operation

As described above, nanostructured materials of the present invention comprise electroactive substances that are contained within an enclosed volume that is separated from space outside of the nanostructured material by a selectively permeable structure. In certain embodiments, the provided nanostructured materials comprise a contained liquid phase that is enclosed within the nanostructured material and separated from the volume outside of the nanostructured material by the selectively permeable structure. Such materials have unique advantages in that the conditions and compositions present in the enclosed volume can be controlled to optimize electrochemical reactions occurring within the volume independent of the conditions and compositions existing outside of the enclosed volume. This feature permits substances to be present at the site of cathode electrochemistry that may not be desirable for anode chemistry and vice versa.

In certain embodiments, the fraction of the enclosed volume that is occupied by the contained liquid phase is controlled to optimize characteristics of the nanostructured material. In certain embodiments, the contained liquid phase occupies between 5 and 80 percent of the enclosed volume. In certain embodiments, the contained liquid phase occupies less than about 30% of the enclosed volume—for example, between about 5 and about 10%; between about 10 and about 20%; between about 15 and about 25%; between about 20 and about 30%; or between about 25 and about 30%. In certain embodiments, the contained liquid phase occupies less than about 40% of the enclosed volume—for example, between about 25 and about 40%; between about 30 and about 40%; or between about 35 and about 40%. In certain embodiments, the contained liquid phase occupies less than about 50% of the enclosed volume—for example, between about 25 and about 50%; between about 30 and about 50%; or between about 40 and about 50%. In certain embodiments, the contained liquid phase occupies more than about 10% of the enclosed volume; more than about 15%, more than about 20%, more than about 30%, more than about 40%, or more than about 50% of the enclosed volume. In certain embodiments, the contained liquid phase, the contained electroactive substance(s) and any other contained additives occupy essentially 100% of the contained volume. In certain embodiments, the contained liquid phase, the contained electroactive substance(s) and any other contained additives occupy less than 100% of the contained volume. In certain such embodiments, the balance of the contained space is occupied by a gas or by a vacuum.

In certain embodiments, the liquid phase in the enclosed volume of the provided nanostructured materials contains one or more species to which the selectively permeable structure is substantially impermeable—such species are thereby substantially trapped in the enclosed volume such species are referred to herein as ‘trapped species’. In certain embodiments such trapped species comprise additives that facilitate the electrochemical conversion of sulfur to lithium sulfide.

In certain embodiments, the provided nanostructured materials are characterized in that they comprise:

a) a contained volume enclosing: a contained liquid phase, a contained electroactive material, and one or more contained additives; and

b) a selectively permeable structure separating the contained volume from a volume outside of the nanostructured material,

wherein the selectively permeable structure is permeable to at least one component of the contained liquid phase, and substantially impermeable to at least one contained additive.

In certain embodiments, the contained electroactive substance in such nanostructured materials changes volume upon undergoing electrochemical conversion and the nanostructured material is characterized in that the enclosed volume is at least 25% larger than the maximum volume occupied by the contained electroactive substance in its most voluminous state.

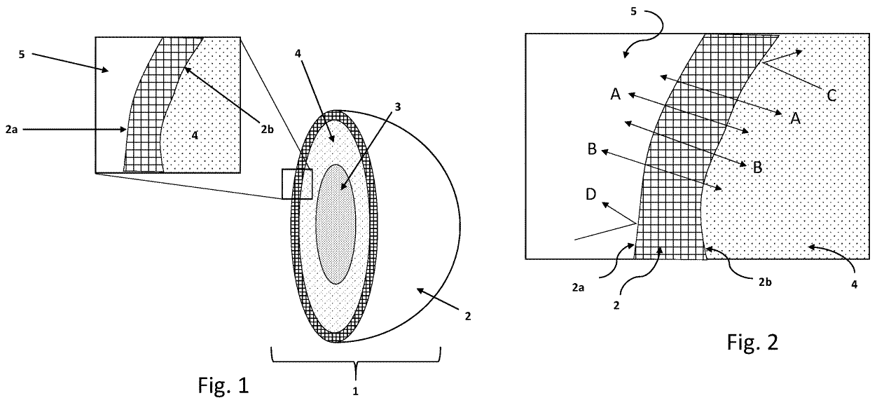

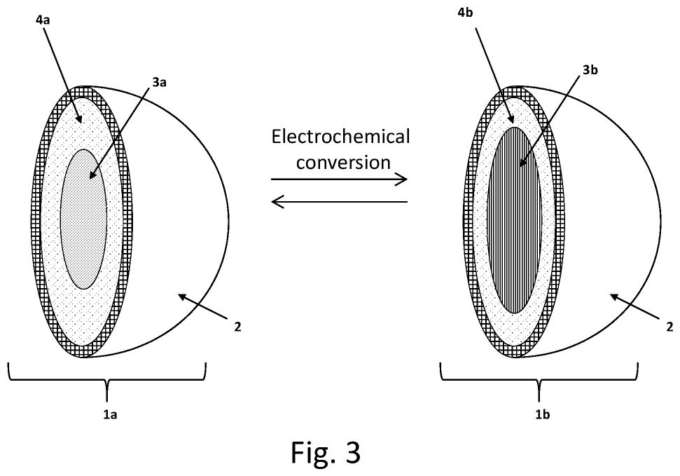

As mentioned above, one of the simplest morphologies for nanostructured materials of the present invention is a core shell nanoparticle. FIG. 1 shows a representative core shell nanoparticle 1 having certain features of the inventive nanostructured materials. The particle 1 comprises a selectively permeable shell 2 surrounding an enclosed volume, which is occupied by a contained liquid phase 4 and a contained electroactive solid 3. The inset shows that the selectively permeable shell has an outer surface 2a and an inner surface 2b. Outer surface 2a is in contact with a volume 5 outside of the nanoparticle while inner surface 2b is in contact with the contained liquid phase 4. FIG. 2 shows the same portion of core shell particle 1 in this view the contained liquid phase 4 contains three species labeled A, B, and C, while the outside volume 5 contains three species A, B, and D. In this depiction, the selectively permeable shell 2 is permeable to species A and B, but not to C or D. This means that species D is excluded from entering the contained liquid phase 4 while species C is prevented from exiting the contained volume 4 and entering the outside volume 5.

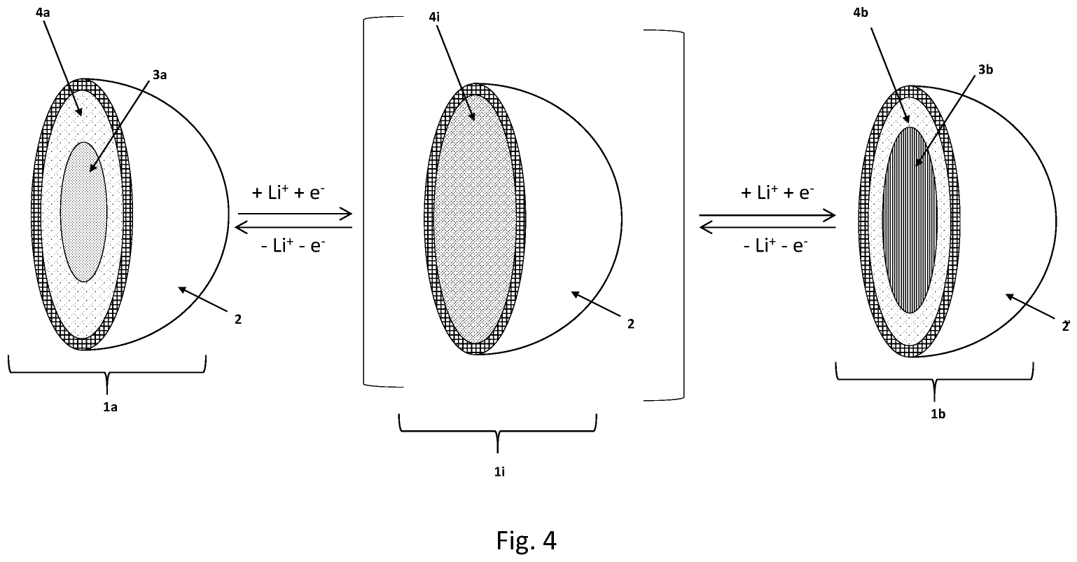

FIG. 3 depicts cross sections of a core shell nanoparticle according to the present invention at two different states of charge. The particle 1a on the left-hand side of FIG. 3 is depicted in a state of charge where the contained electroactive solid 3a has a first volume. In this state, the enclosed volume contains a large volume of liquid phase 4a. After electrochemical conversion, the particle is converted to state 1b where the contained electroactive solid 3b has increased in volume and the contained liquid phase 4b has a correspondingly reduced volume. In both states 1a and 1b, the selectively permeable shell 2 remains substantially unchanged in shape and size, meaning the total volume contained is substantially unchanged. This is possible because of the permeability of shell 2—as the contained electroactive solid expands, liquid from the contained liquid phase 4a permeates through the shell to the external volume 5. When the electrochemical cycle is reversed, the contained electroactive solid shrinks and liquid is able to permeate through the shell 2 to increase the contained liquid phase 4.

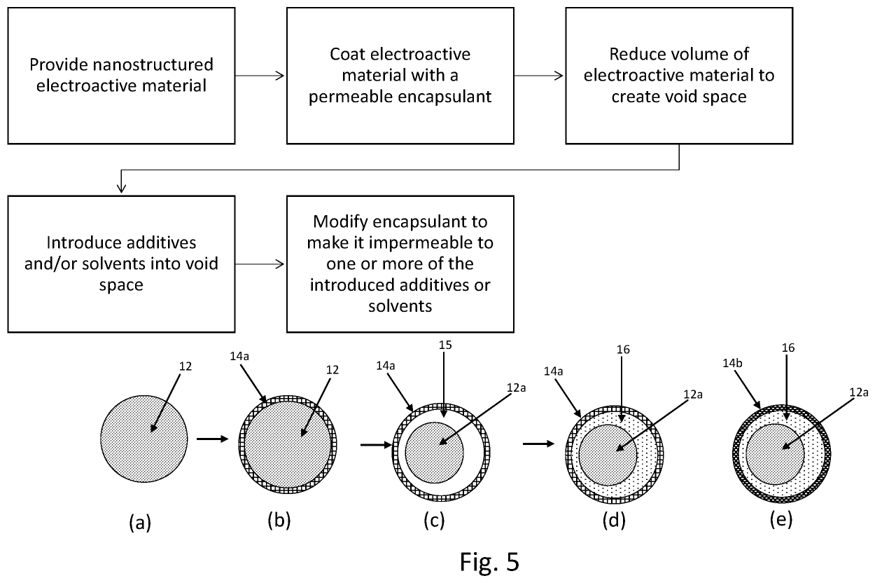

FIG. 4 further illustrates the operation of certain embodiments of the provided inventive nanoparticles. FIG. 4, shows a cross sectional view of a core shell nanoparticle where the contained electroactive substance is elemental sulfur and where the particle is part of an operating lithium sulfur battery. In this case the particle 1a depicted at left-hand side of the figure is in a charged state and the contained electroactive solid 3a comprises solid sulfur. As the particle is electrochemically discharged, lithium ions and electrons enter the particle and convert the sulfur to soluble lithium polysulfides (e.g. Li₂Sₓ where 2<x<9) which dissolve in the contained liquid phase 4a leading to a particle in state 1i depicted at the center of FIG. 4. In this state, the sulfur has been entirely converted to polysulfides, which have dissolved into the contained liquid phase 4i. Further discharge leads to the formation of Li₂S, which has low solubility resulting in formation of solid Li₂S core 3b in contact with liquid phase 4b. Note that solid 3b occupies a larger volume than 3a since the solid now includes the added lithium atoms and lithium sulfide has a lower density than elemental sulfur. Nonetheless, the volume contained by the shell 2 remains approximately constant during all three stages of conversion depicted in FIG. 4—in other words the total volume of electroactive solid 3b and contained liquid phase 4b is approximately equal to the volume of electroactive solid 3a and contained liquid phase 4a. This is possible since, as the volume expansion of the contained electroactive substance increases the pressure in the contained volume, the selectively permeable structure (e.g. shell 2) allows a sufficient volume of solvent to permeate through the shell to equilibrate the created pressure differential. For this reason, an important feature of certain nanostructured materials provided by the present invention is that they have a permeability to at least one component of the contained liquid phase sufficient to allow the permeation of a volume of liquid out of the contained liquid phase at a rate sufficient to permit pressure equilibration at a desired discharge rate of a battery incorporating such nanostructures in an electrode.

In certain embodiments, nanostructured materials of the present invention comprise a contained volume that is separated from a volume outside of the nanostructure by a selectively permeable structure wherein the contained volume encloses a contained electroactive substance and a contained liquid electrolyte that is in contact with the contained electroactive substance, and wherein the selectively permeable structure has a sufficient permeability to constituents of the contained liquid electrolyte to permit permeation of a volume fraction of the contained liquid electrolyte that is at least equivalent to a volume increase in the contained electroactive substance as the substance changes its state of charge. In certain embodiments, such nanostructured materials comprise:

a) a contained volume (Vₜₒₜ) that is separated from a volume outside of the nanostructured material by the selectively permeable structure;

b) a contained electrolyte (contained within Vₜₒₜ) having a total volume (Vₑ) and comprising a volume fraction (Vₚ) of components to which the selectively permeable structure is permeable, and a volume fraction (Vᵢₘₚ) to which the selectively permeable structure is substantially impermeable; and

c) a contained electroactive substance having a first volume (Vᵢ) at an initial charged state and a second volume (V_{f}) at a final charged state where Vᵢ and V_{f} differ by a volume ΔV_{if}.

In certain embodiments such nanostructured materials are characterized in that Vₚ is greater than or equal to ΔV_{if}. In certain such embodiments, Vₚ is at least 25% greater than ΔV_{if}. In certain such embodiments, Vₚ is at least 50%, at least 60%, at least 70%, at least 80%, or at least 100% greater than ΔV_{if}. In certain such embodiments, Vₚ is at least twice, at least three times, at least four times, or at least five times greater than ΔV_{if}.

In certain embodiments, such nanostructured materials are characterized in that the contained volume Vₜₒₜ does not change by more than 10% between the initial and final charged states. In certain embodiments, such nanostructured materials are characterized in that the contained volume Vₜₒₜ does not change by more than 15%, more than 20%, more than 25%, more than 30%, or more than 40% between the initial and final charged states. In certain embodiments, the change in Vₜₒₜ can be determined experimentally by measuring the size of the nanoparticles by microscopy at different states of charge (e.g. in the initial and final charged states).

In certain embodiments, such nanostructured materials are characterized in that a volume fraction of one or more substances comprising Vᵢₘₚ relative to Vₜₒₜ does not change by more than 10% between the initial and final charged states. In certain embodiments, such nanostructured materials are characterized in that the volume fraction of one or more substances comprising Vᵢₘₚ relative to Vₜₒₜ does not change by more than 15%, more than 20%, more than 25%, more than 30%, or more than 40% between the initial and final charged states.

In certain embodiments, such nanostructured materials are characterized in that the volume fraction Vₚ of one or more permeable substances (i.e., a substance that shows sufficient ability to permeate through a selectively permeable structure as described herein, e.g., via the indirect measurement of permeability described in Example 5) changes by more than 10% between the initial and final charge states.

In certain embodiments, such nanostructured materials are characterized in that the volume fraction Vₚ of permeable substances within the contained volume changes by an amount ΔVₚ between the initial and final charge states. In certain such embodiments, ΔVₚ is approximately equal to but opposite from the change in the volume of the electroactive substance ΔV_{if} between the initial and final charge states.

In certain embodiments, such nanostructured materials comprise a selectively permeable structure with a permeability sufficient to allow a portion of the substances comprising Vₚ to permeate through the selectively permeable structure to maintain the contained volume within 10% of its initial value throughout the conversion of substantially all of the contained electroactive substance at a rate of at least 0.1 C. In certain embodiments, such nanostructured materials comprise a selectively permeable structure with a permeability sufficient to allow a portion of the substances comprising Vₚ to permeate through the selectively permeable structure to maintain the contained volume within 15%, within 20%, within 25%, within 30%, or within 40% of its initial value throughout the conversion of substantially all of the contained electroactive substance at a rate of at least 0.1 C. In certain embodiments, the permeability is sufficient to maintain the contained volume within 10% of its initial value throughout the conversion of substantially all of the contained electroactive substance at a rate of at least 0.2 C, at least 0.5 C, at least 1 C, at least 2 C, or at least 5 C. In certain embodiments, the permeability is sufficient to maintain the contained volume within 15%, within 20%, within 25%, within 30%, or within 40% of its initial value throughout the conversion of substantially all of the contained electroactive substance at a rate of at least 0.2 C, at least 0.5 C, at least 1 C, at least 2 C, or at least 5 C.

In certain such embodiments, the selectively permeable structure has a permeability to permeable substances comprising the permeable volume fraction Vₚ of the contained electrolyte of P¹ (L·m⁻²·hr⁻¹), and an interior surface area Aᵢₙₜ (m⁻²) in contact with the contained liquid phase. In certain such embodiments, the nanostructured material is characterized in that the rate defined by the product P¹Aᵢₙₜ is greater than the rate of volume change of the contained electroactive substance during the charge or discharge of the contained electroactive substance when the rate of charge is at least 0.1 C. In certain embodiments, the rate defined by the product P¹Aᵢₙₜ is greater than the rate of volume change of the contained electroactive substance during the charge or discharge of the contained electroactive substance when the rate of charge is at least 0.2 C, at least 0.5 C, at least 1 C, at least 2 C, or at least 5 C.

A characteristic of certain nanostructured materials of the present invention is that the composition of the contained liquid phase changes as the state of charge of the contained electroactive solid changes. Referring again to FIGS. 3 and 4, this means that the concentration of a component of the liquid phase 4a is higher than the concentration of the same component in state 4b (or vice versa). In general, the operational characteristics of the nanostructured materials are such that the concentration of components to which the selectively permeable structure has little or no permeability will be increased in state 4b relative to state 4a, while components to which the selectively permeable structure is highly permeable may be lower in state 4b than in state 4a.

In certain embodiments, the contained liquid phase 4 contains a mixture comprising components to which the selectively permeable structure has little or no permeability and other components to which the selectively permeable structure has high permeability—such particles are characterized in that in a first state of charge the concentration of the impermeable components is lower in a first state and increases to a higher concentration at a second state of charge by virtue of the fact that some portion of the permeable components present in the contained liquid phase in the first charge state will be forced to permeate out of the contained liquid phase (through the selectively permeable structure) as the volume of the contained electroactive substance increases. Therefore, in certain embodiments, the concentration of a contained impermeable component increases due to a decrease in the quantity of other components present in the contained liquid phase rather than due to any increase in the amount of the impermeable component within the particle. In certain embodiments, such particles are characterized in that the concentration of an impermeable component of the contained liquid phase at a first state of charge is less than the concentration of the impermeable component in a second state of charge. In certain embodiments, the particles are characterized in that in a first state of charge the concentration of the impermeable components is less than 9/10, less than ⅘, less than ¾, less than ⅔, less than ½, less than ⅓, less than ¼, less than ⅕ or less than 1/10 of the concentration of the impermeable components in a second state of charge. In certain such embodiments, the impermeable component is further characterized in that it is not a component of, or derivative from, the contained electroactive substance. In certain such embodiments, the impermeable component is further characterized in that the amount of the impermeable component in the contained volume does not change appreciably during electrochemical cycling between the first and second states of charge. In certain such embodiments, the impermeable component is other than lithium polysulfide. In certain such embodiments, the impermeable component is other than sulfur. In certain such embodiments, the first state of charge is defined as the state in which the contained electroactive substance is in a substantially charged state. In certain such embodiments, the second state of charge is defined as a state in which the contained electroactive substance is at least 50% discharged.

In certain embodiments, the effectiveness of the provided nanostructured materials can be optimized by carefully selecting the identity and abundances of the materials comprising the contained liquid phases. In particular, the following strategies can be employed to optimize the electrochemical capacity and cycle life of the contained electroactive substance(s):
a) The identity and quantity of the components to which the selectively permeable structure has high permeability can be controlled in either or both of the contained liquid phase or the external liquid phase.
b) The identity and quantity of the components of the contained liquid phase to which the selectively permeable structure is substantially impermeable can be manipulated (e.g. the identity and quantity of ‘trapped substances’ can be changed).
c) The identity and quantity of components to which the selectively permeable structure is impermeable and which are present in an external liquid phase with which the nanostructured material is in contact can be manipulated (e.g. the identity and quantity of ‘excluded substances’ can be changed).

With regard to strategy (a), in certain embodiments the contained liquid phase comprises one or more components to which the selectively permeable structure has high permeability—such components will therefore move between the contained volume and the volume outside of the nanostructured material (e.g. between the contained liquid phase and a bulk electrolyte in an electrochemical cell in which the nanostructured material is utilized). It is therefore desirable that such components be non-detrimental to other components of an electrochemical device in which the nanostructured material is utilized. For example, where the contained electroactive substance comprises a sulfur cathode material and the provided nanostructured material is to be utilized in a lithium sulfur battery with a lithium metal anode in contact with the electrolyte, it is desirable for the permeable substances to be compatible with lithium metal. In certain embodiments, suitable permeable substances comprise low molecular weight solvents. In certain embodiments, the permeable substances are organic solvents typically used as electrolytes in sulfur batteries (e.g. low molecular weight ethers, sulfones, or nitriles). In certain embodiments, the permeable substances are low molecular weight solvents that have low polarity or little dipole moment. Such solvents are not typically used as battery electrolytes, because they are not good solvents for lithium salts—nonetheless, such solvents can be utilized in the present system as diluents where the property of being able to readily permeate through the selectively permeable structures within the nanostructured materials provides value by maintaining the internal volume of the nanostructure. Such materials are referred to herein as “permeable diluents”. In certain embodiments, permeable diluents comprise hydrocarbon or fluorocarbon solvents.

With regard to strategy (b) above, in certain embodiments, the contained liquid phase comprises one or more components to which the selectively permeable structure has little or no permeability—such components will therefore be trapped in the contained volume and unable to enter the volume outside of the nanostructured material (e.g. the bulk electrolyte). In certain embodiments such trapped components comprise additives that facilitate the electrochemical conversion between sulfur and lithium sulfide. In certain embodiments such additives comprise lithium salts, such as LiCF₃SO₃, LiClO₄, LiNO₃, LiPF₆, and LiTFSI; ionic liquids, such as 1-ethyl-3-methylimidzaolium-TFSI, N-butyl-N-methyl-piperidinium-TFSI, N-methyl-n-butyl pyrrolidinium-TFSI, and N-methyl-N-propylpiperidinium-TFSI; and superionic conductors, such as sulfides, oxides, and phosphates, for example, phosphorous pentasulfide. In certain embodiments such additives comprise organic amines, or other basic organic compounds such as guanidines, amidines, phosphazenes, and related N-containing molecules. In certain embodiments, such trapped additives have sufficiently high molecular weights to prevent them from readily permeating through the selectively permeable structure. In certain embodiments, such additives are characterized in that they have molecular weights above about 150 g/mol. In certain embodiments, such additives are characterized in that they have molecular weights above about 200 g/mol, above about 250 g/mol, above about 400 g/mol, above about 500 g/mol, above about 750 g/mol, or above about 1000 g/mol (e.g., between about 1000 g/mol and 500,000 g/mol).

In certain embodiments of strategy (b) above, trapped substances comprise solvents to which the selectively permeable structure is substantially impermeable. Without being bound by theory, it is believed the presence of certain solvents (for example, protic solvents) may facilitate the electrochemical interconversion of sulfur and lithium sulfide, but may be incompatible with lithium metal anodes—such solvents are particularly suitable to deploy as trapped solvents in the provided nanostructured materials. In certain embodiments, such trapped solvents have sufficiently high molecular weights to prevent them from readily permeating through the selectively permeable structure. In certain embodiments, such solvents are characterized in that they have molecular weights above about 150 g/mol. In certain embodiments, such solvents are characterized in that they have molecular weights above about 200 g/mol, above about 250 g/mol, above about 400 g/mol, above about 500 g/mol, above about 750 g/mol, or above about 1000 g/mol. In certain embodiments, such trapped solvents comprise ethers, diethers, or polyethers. In certain embodiments, such trapped solvents comprise sulfones, di-sulfones, or polysulfones. In certain embodiments, such trapped solvents comprise nitriles, dinitriles, or polynitriles. In certain embodiments, such trapped solvents comprise thioesters, dithioesters, thiocarbonates, dithiocarbonates, or trithiocarbonates. In certain embodiments, such trapped solvents comprise sulfonamides. In certain embodiments, such trapped solvents comprise protic solvents. In certain embodiments, such trapped solvents comprise high molecular weight alcohols, diols, or polyols. In certain embodiments, such trapped solvents comprise high molecular weight amines, diamines, or polyamines. In certain embodiments, such trapped solvents comprise high molecular weight thiols, dithiols, or polythiols. In certain embodiments, such trapped solvent compositions are characterized in that polysulfides have high solubility therein. In certain embodiments, such solvent compositions are characterized in that the polysulfide Li₂S₈ has a solubility of at least 1 M, at least 2 M, at least 3 M, at least 3 M, or at least 4 M at 25° C. In certain embodiments, such solvent compositions are characterized in that the polysulfide Li₂S₈ has a solubility between 1 M and 10 M at 25° C. In certain embodiments, such trapped solvent compositions are characterized in that polysulfides have low solubility therein. In certain embodiments, such solvent compositions are characterized in that the polysulfide Li₂S₈ has a solubility less than 1 M, less than 0.5 M, less than 0.2 M, less than 0.1 M, less than 50 mM, or less than 25 mM at 25° C.

With regard to strategy (c) above, in certain embodiments, a liquid phase outside of the nanostructured material (e.g. a bulk electrolyte) comprises one or more components to which the selectively permeable structure has little or no permeability—such components will therefore be excluded from the nanostructured material and unable to enter the contained liquid phase or to contact the contained electroactive substance. In certain embodiments such excluded components comprise additives that facilitate the electrochemical conversion of lithium metal or prevent dendrite formation during lithium plating. In certain embodiments such excluded components comprise salts that enhance the ionic conductivity of the electrolyte. In certain embodiments such excluded components comprise additives that react with polysulfides. In certain embodiments, such excluded additives have sufficiently high molecular weights to prevent them from readily permeating through the selectively permeable structure. In certain embodiments, excluded additives are characterized in that they have molecular weights above about 150 g/mol. In certain embodiments, such excluded additives are characterized in that they have molecular weights above about 200 g/mol, above about 250 g/mol, above about 400 g/mol, above about 500 g/mol, above about 750 g/mol, or above about 1000 g/mol (e.g., between about 1000 g/mol and 500,000 g/mol).

In certain embodiments, excluded substances according to strategy (c) above comprise solvents to which the selectively permeable structure is substantially impermeable. Without being bound by theory, it is believed certain solvents may facilitate the electrochemical consumption and re-plating of lithium metal anodes, but may be incompatible with electroactive sulfur cathode materials— such solvents are particularly suitable to deploy as excluded components in combination with the provided nanostructured materials. In certain embodiments, such excluded solvents comprise aliphatic carbonates. In certain embodiments, such excluded solvents comprise dialkyl carbonates. In certain embodiments, such excluded solvents comprise esters or amides. In certain embodiments, such excluded solvents comprise ethers. In certain embodiments, such excluded solvents have sufficiently high molecular weights to prevent them from readily permeating through the selectively permeable structure. In certain embodiments, excluded solvents are characterized in that they have molecular weights above about 150 g/mol. In certain embodiments, such excluded solvents are characterized in that they have molecular weights above about 200 g/mol, above about 250 g/mol, above about 400 g/mol, above about 500 g/mol, above about 750 g/mol, or above about 1000 g/mol (e.g., between about 1000 g/mol and 500,000 g/mol).

As described in the preceding paragraphs the strategies for selecting solvents and additives to which the selectively permeable structures of the provided nanostructured materials are either permeable or impermeable and of placing such materials either inside of the contained volume or in a liquid outside of the nanostructured material presents valuable options to independently optimize the performance of a battery cathode and anode using materials that were previously not practical due to their incompatibility with the relevant counter-electrode. In certain embodiments, the invention therefore provides a system for an electrochemical cell comprising the following components:
a) a cathode comprising a nanostructured material having a contained volume separated from the exterior of the nanostructured material by a selectively permeable structure, the contained volume comprising a contained liquid phase and a contained electroactive sulfur material; and
b) an electrolyte composition in contact with the exterior of the nanostructured material and separated from the contained volume of the nanostructured material by the selectively permeable structure,
wherein:
the contained liquid phase comprises one or more organic solvents to which the selectively permeable structure is highly permeable and one or more trapped substances to which the selectively permeable structure is substantially impermeable, and
the electrolyte composition comprises, in addition to the one or more organic solvents to which the selectively permeable structure is highly soluble, one or more excluded substances to which the selectively permeable structure is substantially impermeable,
where the trapped substances and excluded substances are as defined above and in the genera and subgenera herein.

### II. METHODS

In another aspect, the present invention provides methods of manufacturing the provided nanostructured materials. The art of nanomaterial synthesis and engineering is well advanced and the skilled artisan will be familiar with bountiful literature teaching methods to make nano-sized structures suitable for application in the current invention, including methods for making materials where an electroactive substance is contained within a volume defined by a nanostructure. Nanostructured materials of the present invention may be produced by combining these methods with the specific steps and strategies described herein to control the selective permeability properties of such nanostructures and/or to incorporate into such nanostructured materials a contained liquid phase that is in contact with the electroactive substance and to incorporate within the contained liquid phase trapped substances to which the selectively permeable structure is impermeable. Among other things, the present invention provides methods to achieve these ends.

One approach to producing nanostructured materials comprises the following steps:
a) coating a nanoparticle of an electroactive substance with a permeable encapsulant (e.g., a permeable structure or membrane);
b) reducing the volume of the electroactive substance to create a void space within the encapsulated volume;
c) introducing a liquid phase into the created void space; and
d) modifying the encapsulant to make it substantially impermeable to one or more components of the liquid phase.

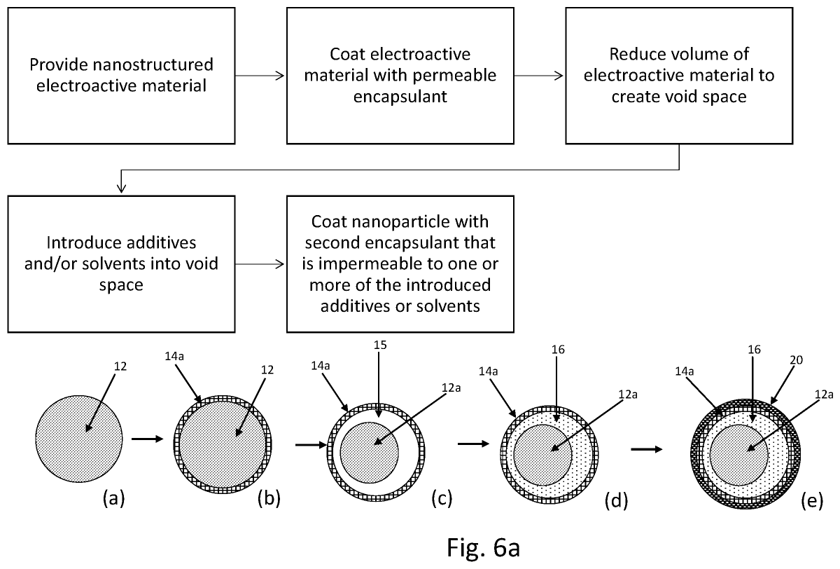

FIG. 5 illustrates a scheme for such a process where the electroactive substance 12 is provided as a spherical nanoparticle (a). The electroactive substance 12 is then coated with a permeable encapsulant 14a to provide core-shell nanoparticle (b). The core shell nanoparticle is then treated to remove a portion of the electroactive core 12 (e.g. by dissolution or sublimation through permeable shell 14a) to provide nanostructure (c) which contains a smaller electroactive core 12a and a void space 15. The void space 15 is then infused with a liquid to provide nanostructure (d) which encompasses contained liquid phase 16 in contact with electroactive core 12a. The shell 14a is then modified to convert it into selectively permeable shell 14b which is substantially impermeable to one or more components of the contained liquid phase 16. In certain embodiments, the step of reducing the volume of the contained electroactive core 12 and introducing the contained liquid phase can be combined—for example, in cases where the electroactive substance has some solubility in the introduced liquid 16, the steps can be accomplished concomitantly by treating particle (b) with an excess of the introduced liquid 16.

While FIG. 5 and other figures that follow illustrate spherical core-shell particles, it will be recognized that a similar process can be utilized for electroactive substances having other morphologies (e.g. an electroactive nanowire, nano-scale platelet or the like could be substituted for the nanosphere 12) to provide other structured nanomaterials with similar operational characteristics.

In certain embodiments, the step of reducing the volume of the contained electroactive core 12 and introducing the contained liquid phase can be combined—for example, in cases where the electroactive substance has some solubility in the introduced liquid 16, the steps can be accomplished concomitantly by treating particle (b) with an excess of the introduced liquid 16.

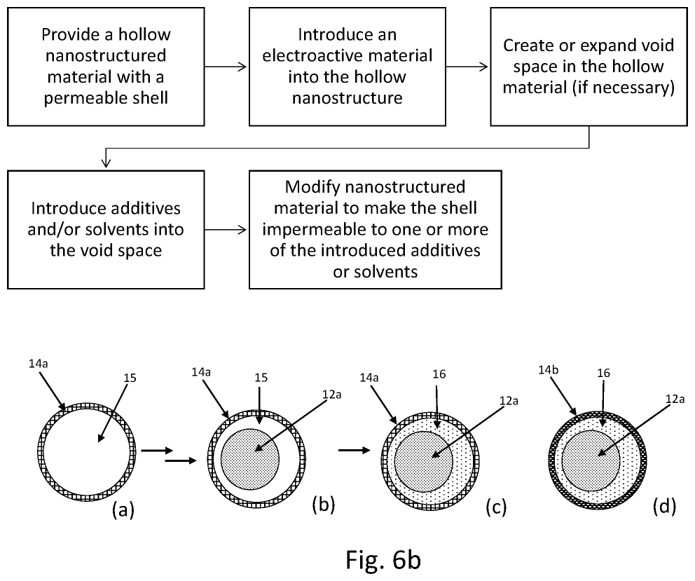

FIG. 6a shows a method similar to that described in FIG. 5, except in this case after forming the nanostructured particle (d) rather than modifying the permeability of the encapsulating shell 12a to change its permeability characteristics, an additional selectively permeable coating 20 is added on top the shell 12 to provide nanostructure (e) having a double layer shell.

FIG. 6b illustrates an alternative method that begins with a pre-formed nanostructure (a) comprising a permeable structure 14a containing a void space 15. Electroactive substance 12a is then introduced into the nanostructure—preferably leaving part of the void space 15 unoccupied as shown in (b). This particle is then treated to introduce liquid phase 16 into the void space as shown at (c). The permeable structure 14a is then treated to transform it into selectively permeable structure 14b which is substantially impermeable to at least one component of the contained liquid phase 16. In certain embodiments, if the step of introducing the electroactive substance into the void space of particle (a) leaves insufficient unoccupied void space, an additional step analogous to the conversion of (b) to (c) in FIG. 5 or 6a may be included in this process to reduce the volume of the electroactive substance 12a prior to introducing liquid phase 16.

In embodiments where the electroactive material 12 or 12a comprises sulfur, the schemes shown in FIGS. 5 and 6a can incorporate known methods of producing sulfur nanoparticles (e.g. producing sulfur particles from the reaction of thiosulfate or polysulfide and an acid, or by precipitating elemental sulfur colloids from suitable solvent/surfactant systems, or by spray drying or milling sulfur or sulfur precursors). Alternatively, nanoparticles of other electroactive sulfur compounds such as lithium sulfide or sulfur-containing polymers can be utilized as particle 12. For the schemes shown in FIG. 6b, known methods for introducing sulfur into structured nanomaterials can be used (e.g. melt or vapor diffusion of elemental sulfur into void spaces).

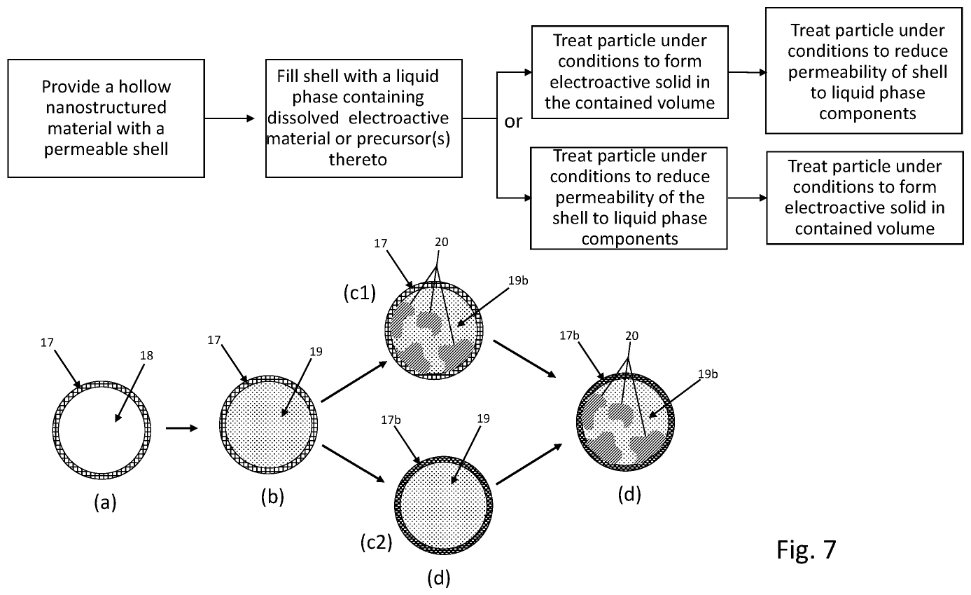

FIG. 7 demonstrates an alternative method of producing nanostructured materials of the present invention where the electroactive material is introduced as part of a liquid phase. For example, a nanostructured material (a) which includes a void space 18 contained within a permeable shell 17 can be treated to introduce into the void space a liquid phase 19 containing a dissolved electroactive substance (or one or more precursors to an electroactive substance) to provide particle (b). This particle can then be treated to convert permeable shell 17 into selectively permeable shell 17b which has reduced permeability to more components of the contained liquid phase 19. Optionally, the resulting particle (c2) can then be treated to produce a contained electroactive solid 20 which separates from a modified contained liquid phase 19b (e.g. by precipitation or an induced chemical reaction). Alternatively, the order of the last two steps can be reversed as shown for particle (c1). In this case, the solid electroactive substance is formed prior to modifying the permeability of the shell.

In certain embodiments conforming to the method of FIG. 7, the liquid phase 19 contains a high concentration of lithium polysulfide (for example, a saturated or near-saturated solution of Li₂S₈ or other lithium polysulfides or polysulfide mixtures of formula Li₂Sₓ where 1<x<9. In certain such embodiments, the solid electroactive substance 20 comprises sulfur and the step of forming the solid electroactive substance 20 comprises electrochemical oxidation of soluble sulfides to sulfur. In certain such embodiments, the solid electroactive substance 20 comprises lithium sulfide (Li₂S) and the step of forming the solid electroactive substance comprises reduction of soluble lithium polysulfide.

In the methods described above (including those shown in FIGS. 5, 6a, 6b, and 7), the step of reducing the permeability of the selectively permeable structure can be accomplished by any number of means. Examples of such steps include: adding additional materials to the structure to reduce or modify its permeability (e.g. by adding additional layers, or by absorbing or adsorbing additional materials into the structure); chemically modifying one or more materials comprising the structure (e.g. by reducing, or oxidizing the material or by functionalizing the material through reaction with reactive substances); by cross-linking one or more materials comprising the structure (e.g. by inducing intramolecular reactions within a material or adding chemical cross-linking reagents to the material); or by physically modifying the structure (e.g. by compressing, stretching, heating, cooling, irradiating, the material or combining two or more such processes); or inducing a change in the crystallinity or morphology of a substance comprising the selectively permeable structure.

In certain embodiments, where the selectively permeable structure comprises a polymer, the step of modifying the permeability of the structure comprises cross-linking the polymer. Polymer cross-linking is a well-developed technology and can be accomplished by many means known to the skilled polymer chemist. The selection of appropriate cross-linking processes depends on the structure of the polymer, the desired degree of cross-linking and the compatibility of the other constituents of the nanostructured material with the processes employed. In certain embodiments, such steps comprise intramolecularly cross-linking a polymer by inducing reaction of functional groups present on the polymer chains. Depending on the polymer, such intramolecular cross-linking can be induced by heat (e.g. a thermal cross-linking process), light (e.g. a photochemical cross-linking process), or by treatment with catalysts. In certain embodiments, such steps may comprise cross-linking by reaction with a cross-linking agent—in certain embodiments, such chemical cross-linking may comprise treatment with polyfunctional reactants that can react at multiple sites or multiple times through a single site.

In principle, any molecule capable of forming two or more covalent bonds to polymer chains present in the precursor to the selectively permeable structure can be employed to modify its permeability. A wide range of di- and polyfunctional cross-linking reagents are known in the art, and the skilled artisan can readily select suitable cross-linking agents for a given polymer based on knowledge of chemical reactivity and literature precedents. Common examples of such poly-functional cross-linking agents include aldehydes, dicarbonyl compounds, sulfur or polysulfur compounds, diacid chlorides, alkyl dihalides, diamines, di-epoxides, polyisocyanates, melamine, and the like.

In certain embodiments, nanostructured compositions of the present invention comprise the polymer polyaniline. In certain embodiments, such polyaniline compositions are cross-linked to modify their permeability characteristics. Such cross-linking can be accomplished by heating to induce intramolecular cross-linking, or by reaction with a poly-functional cross-linking agent. Suitable cross-linking agents include molecules having reactive functional groups such as aldehydes, ketones, carboxylic acids, and derivatives of these, such as acetals, ketals, esters, acid chlorides, and the like. In the case of aldehydes and ketones, each carbonyl functional group can condense with two nitrogen atoms in the polyaniline chains thereby creating potential inter-chain cross-links. When a carboxylic acid or derivative (e.g., ester or acid chloride) is utilized, cross-linking requires use of a di- or polyacid (or related derivative).

A similar post-polymerization cross-linking approach comprises reacting polyaniline with di- or poly-electrophiles such as dihalides, or bis-sulfonate esters. Such electrophiles react with polymer nitrogen atoms to form covalent cross-links. A wide range of suitable polyfunctional electrophiles are known in the art and may be utilized for this purpose. Shown below is an example of the cross-linking of PAni by reaction with α,α′-dichloro p-xylene (where squiggly lines indicate the attachment point to a crosslinked unit of PAni).

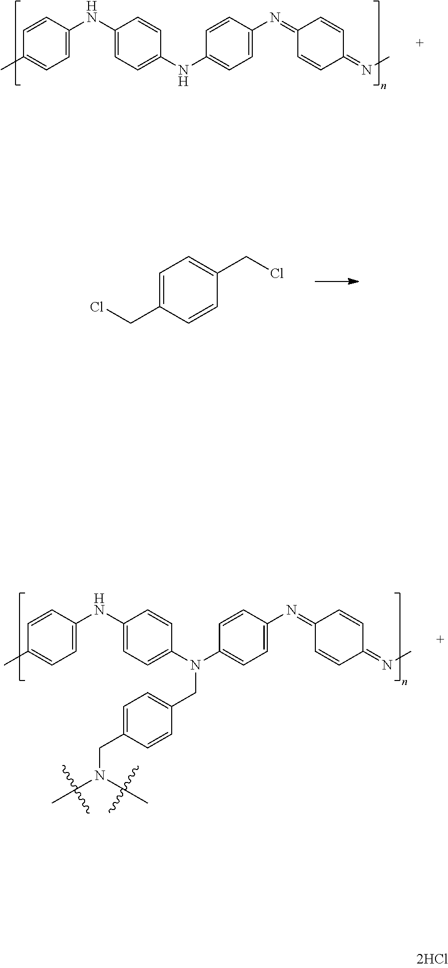

For polymers formed by post-polymerization reaction with polyfunctional cross-link forming reagents, the density of cross-linking can be controlled by modulating the molar ratio of the cross-linking reagent to the polymer repeat units.

While the invention has been primarily described with respect to PAni-based shells, alternative categories of conductive polymers are contemplated and considered within the scope of the invention. Such alternatives include polyheterocycles, such as polythiophenes, polypyrrole, poly(3,4-ethylenedioxythiophene) (PEDOT), poly(3,4-ethylenedioxypyrrole) (PEDOP), as well conductive polyenes and polyarenes (e.g., polystyrene sulfonate). Selectively permeable structures (e.g., polymer shells) are preferably conductive within the operating voltage range of Li/S batteries (e.g., 1.5-2.4 V). For structures of additional conductive polymers, refer to Synthesis, processing and material properties of conjugated polymers, Polymer, Vol. 37, No. 22, pp. 5017-5047, 1996, the entire disclosure of which is incorporated by reference herein.

Generally, the permeability or inverse barrier is an important physical property for many industrial applications of polymers. For example, there are numerous applications for polymers with low, high or tailored (i.e., selective) permeability, such as protective coatings or barriers to control the flow of certain substances. Generally, the transport of substances through polymer barriers (e.g., polymeric shells) is caused by either a pressure or temperature gradient, or by an external force field and/or a concentration gradient. The permeability of a substance through the shell can be very different for different polymers and permeants. In general, permeability and solubility at a given temperature depend on the degree of crystallinity (morphology), the molecular weight, the type of permeant and its concentration or pressure, and in the case of copolymers, also on the composition.

Accordingly, by tailoring the permeability of the selectively permeable structure, it is possible to control which substances are able to enter or not enter the contained volume of the nanostructure, and which substances are able to exit or not exit the contained volume. There are several means for tailoring the permeability of the polymer shell that are described herein. Generally, the selective permeability of the shell is determined by the presence, size, morphology (e.g., void shapes), and distribution of pores within the polymer shell, which can be controlled by, for example acid doping, dedoping and redoping, cross-linking, the introduction of certain additives, or combinations thereof during the polymerization process, or in some cases as part of a post-polymerization process.

Various examples of acid doping, chemical and thermal cross-linking, and the use of certain additives are disclosed in “Polyaniline Membranes for Use in Organic Solvent Nanofiltration” by Xun Xing Loh, Dept. of Chemical Engineering and Chemical Technology Imperial College of London, April 2009; and PCT Publication Nos. WO2017/091645 and WO2018/049013, the entire disclosures of which are incorporated by reference herein.

The reaction scheme for the acid doping and dedoping of PAni emeraldine base is shown below, where HX represents the acid and X is the acid counter ion. The doping/dedoping process can induce a certain degree of porosity into the polymer shell giving rise to the selective permeability of the shell.

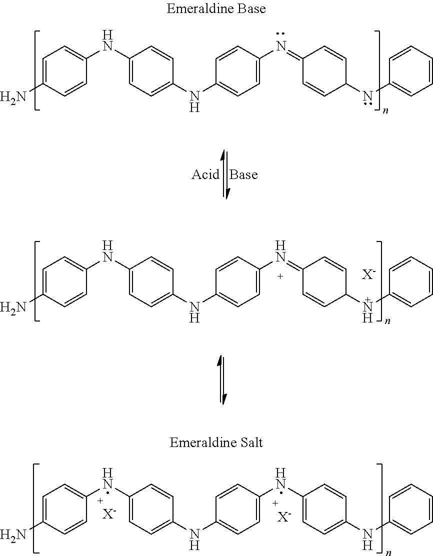

The selectivity of the permeable polymer shell can be tuned by using a particular acid in the doping, dedoping, and redoping processes, either with or without cross-linking or the use of other additives. Acids such as dodecyl benzene sulfonic acid, camphor sulfonic acid, and p-phenol sulfonic acid have been shown to be effective in tuning the selective permeability of the shell. The selective permeability of the shell can be further tuned by the inclusion of additives, such as phenanthrene, pyrene, triphenyl phosphate, and polystyrene.

In certain embodiments, it is desirable to decrease the permeability and selectivity of the selectively permeable structure to suit a particular application (e.g., the particular substances that need to be retained within or excluded from the contained volume). The use of unbound additives and/or changing the solvent composition of the dope solution can decrease the permeability and selectivity of the selectively permeable structure.

Certain porosities can be induced in various polymers by a sequence of doping, dedoping, and redoping with particular acids. For example, doping with hydrochloric acid results in a highly selective permeability. In some embodiments, the induced porosity can be dependent on the size of the acid counter ion. Other possible acids can include halogenic acids, sulfonic acids such as toluene sulfonic acid, methane sulfonic acid, substituted aryl sulfonic acids, and long-chain aliphatic sulfonic acids, and carboxylic acids, such as formic acid, acetic acid, and propionic acid.

Without wishing to be bound to a particular theory, the permeability properties of the selectively permeable structure can be tuned by entrapping acid dopants as pore templating agents in a polymer matrix composing the structure and by subsequently creating permeation pathways by removing these dopants via alkaline extraction. In a particular embodiment, an unprotonated polyaniline is exposed to various strong acids. The strong electrostatic interactions involved in the protonation of the polyaniline nitrogen atoms, through a strong acid, forces the polymer network to conformationally re-organize, so as to accommodate the proton of the acid and the counter ion. Subsequent removal of the acid results in inducing porosity due to the removal of acid from the newly formed cavities in the polymer matrix as shown in the illustration below.

[symbol]

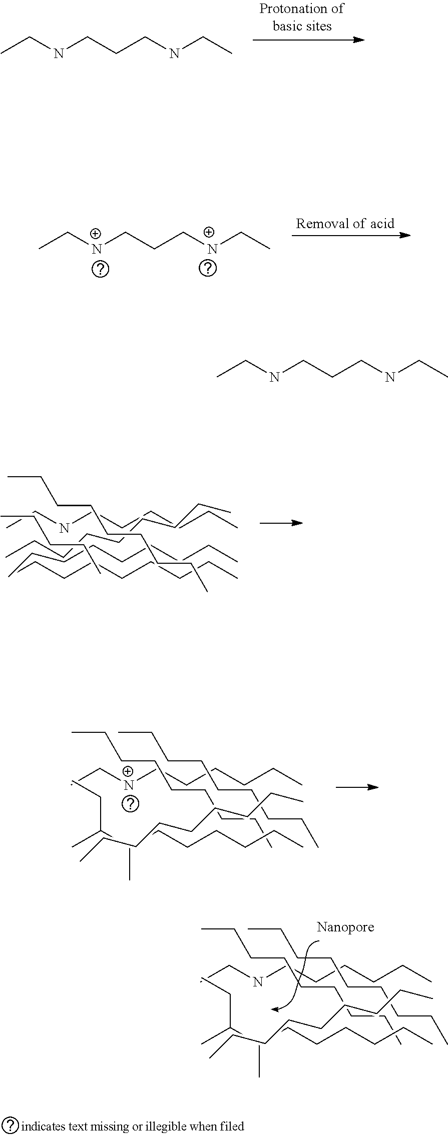

Partial redoping of the dedoped structure can have an additional effect on permeability of the polymer as the inclusion of different sized acid counter ions leads to a change in the dimensions of the pores.

Similar approaches can be used to control the permeability of other polymers to create suitable selectively permeable structures as can other means known in the art to template nano pores in polymeric compositions.

### III. MIXTURES AND ELECTRODE COMPOSITIONS

As mentioned above, the nanostructured materials of the present invention have utility in the manufacture of electrochemical devices. Generally, the nanostructured materials disclosed herein would be physically combined with other materials to create formulated mixtures which have utility for the manufacture of electrodes for electrochemical devices and, in particular, mixtures useful for forming cathodes in secondary lithium batteries. In one aspect, the present invention provides such cathode compositions (e.g., mixtures). Typically, provided mixtures will include one or more of the nanostructured materials described hereinabove (e.g., core-shell particles, etc.), in addition to additives such as electrically conductive particles, binders, and other functional additives typically found in battery cathode mixtures. Generally, provided cathode mixtures include plentiful conductive particles to increase the electrical conductivity of the cathode and provide a low resistance pathway for electrons to access the manufactured cathode. In various embodiments, other additives may be included to alter or otherwise enhance a cathode produced from the mixture. Generally, such mixtures will comprise at least 50 wt. % of a nanostructured material. In certain embodiments, such mixtures comprise at least about 60 wt. %, at least about 75 wt. %, at least about 80 wt. %, at least about 85 wt. %, or at least about 90 wt. % of the nanostructured material. In certain embodiments, such mixtures will comprise about 50 to about 90% of the nanostructured material. In certain embodiments, such mixtures will comprise about 60 to about 90% of the nanostructured material. In certain embodiments, such mixtures will comprise about 60 to about 80% of the nanostructured material. In certain embodiments, such mixtures will comprise about 70 to about 90% of the nanostructured material. In certain embodiments, such mixtures will comprise about 75 to about 85% of the nanostructured material.

In certain embodiments, the inventive nanostructured materials are mixed with the electrically conductive additives (e.g., conductive carbon powders, such as carbon black, Super P®, C-NERGY™ Super C65, Ensaco® black, Ketjenblack®, acetylene black, synthetic graphite such as Timrex® SFG-6, Timrex® SFG-15, Timrex® SFG-44, Timrex® KS-6, Timrex® KS-15, Timrex® KS-44, natural flake graphite, carbon nanotubes, graphene, fullerenes, hard carbon, or mesocarbon microbeads, etc.) and a binder. Typical binders include polyvinylidene fluoride, poly(vinylidene fluoride-co-hexafluoropropene) (PVDF/HFP), Polytetrafluoroethylene (PTFE), Kynar Flex® 2801, Kynar® Powerflex LBG, Kynar® HSV 900, Teflon®, carboxymethylcellulose, styrene-butadiene rubber (SBR), polyethylene oxide, polypropylene oxide, polyethylene, polypropylene, polyacrylates, polyvinyl pyrrolidone, poly(methyl methacrylate), polyethyl acrylate, polytetrafluoroethylene, polyvinyl chloride, polyacrylonitrile, polycaprolactam, polyethylene terephthalate, polybutadiene, polyisoprene or polyacrylic acid, or derivatives, mixtures, or copolymers of any of these. In some embodiments, the binder is water soluble binder, such as sodium alginate or carboxymethyl cellulose. Generally, the binders hold the active materials together and in contact with a current collector (e.g., aluminum foil or copper foil).

In certain embodiments, the provided mixtures can be formulated without a binder, which can be added during the manufacture of the electrodes (e.g. dissolved in a solvent used to form a slurry from the provided mixture). In embodiments where the binders are included in the provided mixture, the binder can be activated when made into a slurry to manufacture the electrodes.

Suitable materials for use in cathode mixtures are disclosed in Cathode Materials for Lithium Sulfur Batteries: Design, Synthesis, and Electrochemical Performance, Lianfeng, et al., Interchopen.com, Published June 1st 2016, and The strategies of advanced cathode composites for lithium-sulfur batteries, Zhou et al., SCIENCE CHINA Technological Sciences, Volume 60, Issue 2: 175-185(2017), the entire disclosures of each of which are hereby incorporated by reference herein.

In another aspect, the present invention provides novel electrode compositions comprising nanostructured materials according to the embodiments described herein. In certain embodiments, the invention provides cathode compositions. Such cathodes typically comprise a layer of electroactive material coated on a highly conductive current collector.

There are a variety of methods for manufacturing electrodes for use in a lithium battery. One process, such as a “wet process,” involves adding a positive active material (i.e., the provided nanostructured materials), a binder and a conducting material (i.e., the cathode mixture) to a liquid to prepare a slurry composition. These slurries are typically in the form of a viscous liquid that is formulated to facilitate a downstream coating operation. A thorough mixing of the slurry can be critical for the coating and drying operations, which will eventually affect the performance and quality of the electrodes. Appropriate mixing devices include ball mills, magnetic stirrers, sonication, planetary mixers, high speed mixers, homogenizers, universal type mixers, and static mixers. The liquid used to make the slurry may be any one that can homogeneously disperse the positive active material, the binder, the conducting material, and any additives, and that can be easily evaporated. Possible slurry liquids include, for example, N-methylpyrrolidone, acetonitrile, methanol, ethanol, propanol, butanol, tetrahydrofuran, water, isopropyl alcohol, dimethylpyrrolidone, and the like.

The prepared composition is coated on the current collector and dried to form the electrode. Specifically, the slurry is used to coat an electrical conductor to form the electrode by evenly spreading the slurry on to the conductor, which may then be roll-pressed (e.g. calendared) and heated as is known in the art. Generally, a matrix of the nanoparticles and conductive material are held together and on the conductor by the binder. In certain embodiments, the matrix comprises a lithium conducting polymer binder, such as polyvinylidene fluoride (PVDF), poly(vinylidene fluoride-co-hexafluoropropene) (PVDF/HFP), Polytetrafluoroethylene (PTFE), Kynar Flex® 2801, Kynar® Powerflex LBG, Kynar® HSV 900, Teflon®, styrene butadiene rubber (SBR), polyethylene oxide (PEO), and polytetrafluoroethylene (PTFE). Additional carbon particles, carbon nanofibers, carbon nanotubes, etc. may also be dispersed in the matrix to improve electrical conductivity. Additionally, lithium ions may also be dispersed in the matrix to improve lithium conductivity.

The current collector may be selected from the group consisting of: aluminum foil, copper foil, nickel foil, stainless steel foil, titanium foil, zirconium foil, molybdenum foil, nickel foam, copper foam, carbon paper or fiber sheets, polymer substrates coated with conductive metal, and/or combinations thereof.

The thickness of the matrix may range from a few microns to tens of microns (e.g., 2-500 microns). In one embodiment, the matrix has a thickness of 10-50 microns. Generally, increasing the thickness of the matrix increases the percentage of active nanoparticles to other constituents by weight, and may increase the cell capacity. However, diminishing returns may be exhibited beyond certain thicknesses. In one embodiment, the film has a thickness of between about 5 and about 200 microns. In a further embodiment, the film has a thickness of between about 10 and about 100, between about 50 and about 100, between about 60 and about 120, between about 75 and about 150, or between about 100 and about 200 microns.

The negative electrode (i.e., anode) contains a negative active material. The negative active material is one that can reversibly provide lithium ions. This may simply be lithium metal, or a substance that can intercalate or de-intercalate lithium atoms or ions. Intercalating materials may include carbon materials, preferably any carbon-based negative active material that is typically used for a lithium battery, such as crystalline carbon, amorphous carbon or a combination thereof. Further, the material, which can reversibly form a lithium-containing compound by reacting with the lithium ions, may include tin oxide (SnO₂), titanium nitrate, silicon (Si), and the like, but not limited thereto. Lithium may be provided in the form of pure lithium or may be provided as an alloy of lithium and metal selected from the group consisting of: Na, K, Rb, Cs, Fr, Be, Mg, Ca, Sr, Ba, Ra, Al, In and Sn. Typically, the negative electrode may also be disposed on a current collector, such as those described above.

PCT Publication Nos. WO2015/003184, WO2014/074150, and WO2013/040067, the entire disclosures of which are hereby incorporated by reference herein, describe various methods of fabricating electrodes and electrochemical cells.

### IV. ELECTROCHEMICAL CELLS

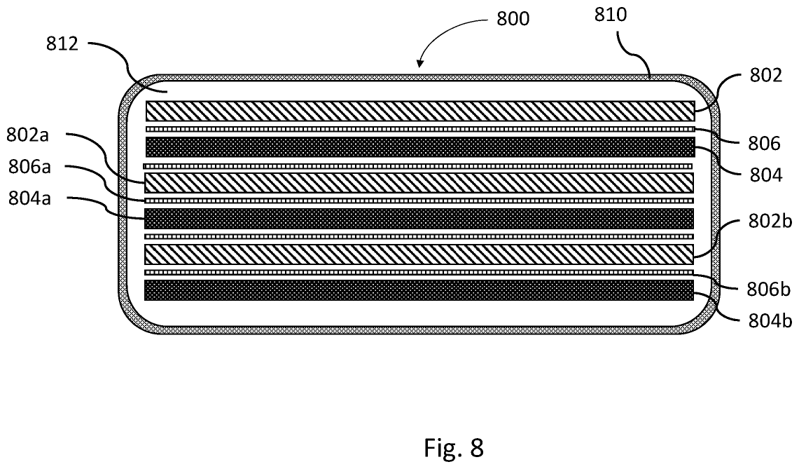

FIG. 8 illustrates a cross section of an electrochemical cell 800 in accordance with exemplary embodiments of the disclosure. Electrochemical cell 800 includes a negative electrode 802, a positive electrode 804, a separator 806 interposed between negative electrode 802 and positive electrode 804, a container 810, and a fluid electrolyte 812 in contact with negative and positive electrodes 802, 804. Such cells optionally include additional layers of electrode and separators 802a, 802b, 804a, 804b, 806a, and 806b.

Negative electrode 802 (also sometimes referred to herein as the anode) comprises a negative electrode active material that can accept cations. Non-limiting examples of negative electrode active materials for lithium-based electrochemical cells include Li metal, Li alloys such as those of Si, Sn, Bi, In, and/or Al alloys, Li₄Ti₅O₁₂, hard carbon, graphitic carbon, metal chalcogenides, and/or amorphous carbon. In accordance with some embodiments of the disclosure, most (e.g., greater than 90 wt % to all) of the anode active material can be initially included in a discharged positive electrode 804 (also sometimes referred to herein as the cathode) when electrochemical cell 800 is initially made, so that the electrode active material forms part of first electrode 802 during a first charge of electrochemical cell 800.

A technique for depositing electroactive material on a portion of negative electrode 802 is described in U.S. Patent Publication No. 2016/0172660 and in U.S. Patent Publication No. 2016/0172661, the contents of each which are hereby incorporated herein by reference, to the extent such contents do not conflict with the present disclosure.

Negative electrode 802 and positive electrode 804 can further include one or more electronically conductive additives as described above.

In accordance with some embodiments of the disclosure, negative electrode 802 and/or positive electrode 804 further include one or more polymer binders as described above.

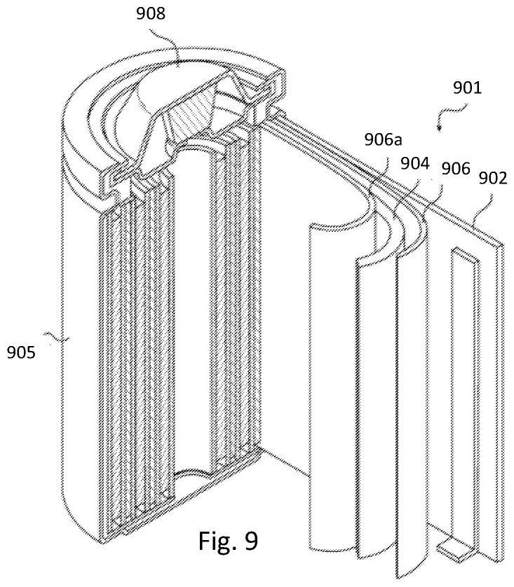

FIG. 9 illustrates an example of a battery in which the above nanostructured materials, methods, and other techniques, or combinations thereof, may be applied according to various embodiments. A cylindrical battery is shown here for illustration purposes, but other types of arrangements, including prismatic or pouch (laminate-type) batteries, may also be used as desired. The example Li battery 901 includes a negative anode 902, a positive cathode 904, a separator 906 interposed between the anode 902 and the cathode 904, an electrolyte (not shown) impregnating the separator 906, 906a, a battery case 905, and a sealing member 908 sealing the battery case 905. It will be appreciated that the example battery 901 may simultaneously embody multiple aspects of the present invention in various designs.

### V. EXAMPLES

The following examples embody certain methods of the present invention and demonstrate the fabrication of a nanostructured materials according to certain embodiments herein.

### Example 1: Core Shell Nanoparticles Featuring Electroactive Sulfur in a Selectively Permeable Shell

Step 1: Formation of Sulfur Nanoparticles. Sulfur nanoparticles are prepared via the reaction of aqueous sodium thiosulfate with excess hydrochloric acid in the presence of 1 wt % of polyvinylpyrrolidone (PVP, Mw about 40,000). The freshly prepared sulfur particles are isolated by centrifugation and analyzed by SEM to confirm the composition consists of spherical sulfur having particles with an average diameter less than 1000 nm and a narrow size distribution.

Step 2: Formation of Core Shell Particles. The sulfur nanoparticles from step 1 are dispersed in water by sonication. To the resulting suspension, aniline and dilute sulfuric acid are added. The suspension is maintained at 0° C. under strong stirring for 12 hours. The particles are isolated by centrifugation and rinsed with water. Cryogenic TEM analysis of the particles shows they comprise nanoscale spherical particles with a core-shell morphology featuring a sulfur core conformally coated with PAni shells (S@PAni) and reveals that the PAni shells have thicknesses between 10 and 50 nm (the thickness is varied by controlling the amount of aniline used and the length of time the polymerization is allowed to proceed).

Step 3: Formation of Yolk-Shell Particles. The S@PAni nanoparticles are re-suspended in a calibrated volume of 1:1 water/isopropanol, the suspension is stirred and aliquots are taken periodically, filtered to remove the nanoparticles, weighed, and analyzed by combustion analysis to determine the amount of dissolved sulfur present. Once combustion analysis of the filtrate shows that 50% of the sulfur present in the S@PAni particles has dissolved, the suspension is centrifuged, and the isolated nanoparticles are rinsed twice with water and dried. These particles are again subjected to cryogenic TEM analysis which reveals that the particles now have a ‘yolk-shell’ morphology and feature a PAni shell containing a void space along with a sulfur yolk. TEM analysis indicates that, on average, the void space occupies about ½ of the contained volume within the PAni shell.

Step 4: Introduction of a Contained Liquid Phase. The core shell S@PAni nanoparticles are placed in a thick walled glass tube outfitted with a valved cap plumbed to vacuum and a nitrogen manifold. The tube is briefly subjected to a vacuum of 50 mTorr before a mixture of diglyme containing 10% (v/v) octanedinitrile is introduced to the evacuated tube. The headspace pressure is then normalized by introduction of nitrogen gas, and then alternately cycled between 100 psig and ambient pressure.

Step 5: Modification of the Permeability of the PAni Shell. To modify permeability of the PAni shell, a sequence consisting of doping and then cross-linking the polyaniline is used. To the diglyme/octanedinitrile suspension of particles formed in step 5, an excess of dodecyl benzene sulfonic acid (DBSA) is added to dope the polyaniline. Upon addition of DBSA, the color of the particles changes from light grey to dark blackish-green. The mixture is stirred for 1 h, then glutaraldehyde is added as a cross-linking agent and the mixture heated to 60° C. After stirring for 4 h at this temperature, the mixture is cooled to ambient temperature, centrifuged, and the isolated particles are rinsed twice with NMP and dried.

### Example 2: Modification of Permeability by Doping and Thermally Cross-Linking PAni

Example 2 is performed according to the protocols of Example 1, except that at step 5, instead of chemically cross-linking with glutaraldehyde, the PAni shell is intramolecularly cross-linked by heat-treating the Doped particle suspension at 180° C. for 6 h. In a variation of this example, the doped PAni particles are isolated by centrifugation prior to heat-treating in a 180° C. oven for 4 h.

### Example 3: Modification of Permeability by Acid Doping and Dedoping

Example 3 is performed according to the protocols of Example 1, except that at step 5 modification of the permeability is performed by doping and dedoping the PAni shell with acid. A suspension of the nanoparticles is treated with dodecyl benzene sulfonic acid (DBSA). Protonation of the polyaniline nitrogen atoms induces a conformational change in the polymer network. After 1 h, the nanoparticles are treated with a base to deprotonate the polyaniline nitrogen atoms and remove the acid. The doped/dedoped PAni particles are isolated by centrifugation. The particles are subjected to cryogenic TEM analysis to measure the porosity of the PAni shells.

### Example 4: Combined Sulfur Dissolution and Contained Liquid Phase Introduction

Example 4 is performed according to the protocols of Example 1, except that a mixture of diglyme, octanedinitrile and toluene (10:1:2 by volume) is used as the solvent for the sulfur removal described in step 3. The resulting suspension is then used directly for step 5.

### Example 5: Change of Doping Agent Size to a Smaller Acid to Modulate Permeability of the Cross-Linked Nanostructured Material

In order to create a PAni shell with lower permeability, a smaller doping acid can be used. To this end, Example 5 is performed according to the protocols of Example 1, except different acids are used to dope the PAni at step 5. A series of separate samples are processed using naphthalene 1-sulfonic acid, p-toluene sulfonic acid, methane sulfonic acid, trifluoroacetic acid, and hydrobromic acid as the doping agent in place of DBSA.

The resulting nanostructured materials are then isolated and then evaluated for the ability of the constituents of the contained liquid phase (e.g. diglyme and octanedinitrile) to permeate through the cross-linked PAni shell. This evaluation is done by stirring the nanoparticles in electrolyte (e.g. 1:1 DME/DOL containing 1 M LiTFSI and 0.2 M LiNO₃) for 72 hours and periodically sampling the mixture, filtering it and analyzing the supernatant by GC to assay the amount of diglyme and octanedinitrile in the DME/DOL. The concentration of these substances and their rate of increase over the 72 h study are correlated to the permeability of the PAni shell to these substances and the samples having the lowest concentrations are those having shells with the lowest permeability. In another approach, a cathode is formed by combining samples of the nanostructured materials with conducting carbon and a PVDF binder in an NMP slurry and coating an aluminum current collector with the mixture. A strip of this cathode is then placed in an electrochemical cell containing a lithium metal anode and an electrolyte (1:1 DME/DOL containing 1 M LiTFSI and 0.2 M LiNO₃) and sampling the electrolyte for gas chromatographic analysis as the cell is alternately charged and discharged. Again, the concentration of diglyme and octanedinitrile in the electrolyte is used as an indirect measurement of the permeability of the PAni shells to these substances. In addition, the electrolyte in each cell is analyzed by spectrophotometry to assay the concentration of lithium polysulfides present in the electrolyte. These values are correlated to the permeability of the PAni shells to polysulfide and/or to the ability of the core shell particles to accommodate the solvent flux caused by volume changes of the electroactive sulfur core. The cycled cathodes are evaluated by SEM to assess whether the core shell particles are intact and differentiate whether higher polysulfide concentrations result from breakage of nanoparticles or permeation of polysulfides through the particle shells.

### Example 6: Change of Doping Agent Size to a Smaller Acid to Modulate Permeability of the Doped/Dedoped Nanostructured Material

In order to create a PAni shell with lower permeability, a smaller doping acid can be used for doping and dedoping. To this end, Example 6 is performed according to the protocols of Example 3, except different acids are used to dope the PAni. A series of separate samples are processed using formic acid, acetic acid, propionic acid, and hydrochloric acid as the doping agent in place of DBSA. The permeability of these samples was assessed according to the protocols of Example 5.

### Example 7: Use of Elemental Bulk Sulfur

Example 7 is performed according to the protocols of Example 1, except elemental sulfur that has been ball-milled to sub-micron particles is suspended in an aqueous solution and used for step 2, instead of the synthesized sulfur nanoparticles of step 1 of Example 1.

It is contemplated that compositions, systems, devices, methods, and processes of the present application encompass variations and adaptations developed using information from the embodiments described in the present disclosure. Adaptation or modification of the methods and processes described in this specification may be performed by those of ordinary skill in the relevant art.

It will be appreciated that use of headers in the present disclosure are provided for the convenience of the reader. The presence and/or placement of a header is not intended to limit the scope of the subject matter described herein. Unless otherwise specified, embodiments located in one section of the application apply throughout the application to other embodiments, both singly and in combination.

Throughout the description, where compositions, compounds, or products are described as having, including, or comprising specific components, or where processes and methods are described as having, including, or comprising specific steps, it is contemplated that, additionally, there are articles, devices, and systems of the present application that consist essentially of, or consist of, the recited components, and that there are processes and methods according to the present application that consist essentially of, or consist of, the recited processing steps.

It should be understood that the order of steps or order for performing certain action is immaterial so long as the described method remains operable. Moreover, two or more steps or actions may be conducted simultaneously.

### EXEMPLARY EMBODIMENTS

The present disclosure contemplates, among other things, the following numbered embodiments:

Embodiment 1. A nanostructured material comprising a contained volume that is physically separated from a volume outside of the nanostructure, wherein the contained volume encloses a contained electroactive substance and a contained liquid phase in contact with the contained electroactive substance.

Embodiment 2. A nanostructured material comprising a contained volume that is physically separated from a volume outside of the nanostructure by a permeable membrane, wherein the contained volume encloses an electroactive substance and a contained liquid phase in contact with the electroactive substance.

Embodiment 3. A nanostructured material comprising a contained volume that is physically separated from a volume outside of the nanostructure by a selectively permeable membrane, wherein the contained volume encloses an electroactive substance and a contained liquid phase in contact with the electroactive substance.

Embodiment 4. The nanostructured material of any one of embodiments 1 to 3, wherein the electroactive substance comprises sulfur.

Embodiment 5. The nanostructured material of embodiment 4, wherein the electroactive sulfur material is in the form of elemental sulfur, sulfur-containing organic molecules, polymers or composites, metal sulfides, or mixtures thereof.

Embodiment 6. The nanostructured material of embodiment 4 or 5, wherein the electroactive sulfur material comprises S₈.

Embodiment 7. The nanostructured material of any one of embodiments 4 to 6, wherein the electroactive sulfur material forms a composite with one or more additional materials selected from the group consisting of: graphite, graphene, chalcogenides, metal sulfides, metal oxides, conductive polymers, or mixtures thereof.

Embodiment 8. The nanostructured material of any one of the preceding embodiments, wherein the electroactive substance comprises about 20% to about 80% of the contained volume.

Embodiment 9. The nanostructured material of any one of the preceding embodiments, wherein the contained liquid phase comprises about 20% to about 80% of the contained volume.

Embodiment 10. The nanostructured material of any one of the preceding embodiments, wherein the nanoparticle has a substantially spherical shape.

Embodiment 11. The nanostructured material of any one of embodiments 2 to 10, wherein the membrane has a dimension of about 10 to 1000 nm.

Embodiment 12. The nanostructured material of any one of embodiments 2 to 11, wherein the membrane has a wall thickness of about 0.5 to 100 nm.

Embodiment 13. The nanostructured material of any one of embodiments 2 to 12, wherein the membrane comprises a polymer selected from the group consisting of: polyethylene, polypropylene, polytetrafluoroethylene (PTFE), polyvinylidene difluoride (PVDF), polysulfone, polyethersulfone, polyacrylonitrile, polyamide, polyimide, polyamideimide, polyetherimide, cellulose acetate, polyaniline, polypyrrole, polyetheretherketone (PEEK), polybenzimidazole, and derivatives, mixtures or co-polymers thereof.

Embodiment 14. The nanostructured material of any one of embodiments 2 to 12, wherein the membrane comprises one or more electronically conductive polymers.

Embodiment 15. The nanostructured material of embodiment 14, wherein at least one electronically conductive polymer is selected from the group consisting of: polyaniline, polydopamine, polypyrrole, polyselenophene, polythiophene, polynaphthalene, polyphenylene sulfide, and derivatives, mixtures or copolymers thereof.

Embodiment 16. The nanostructured material of embodiment 14, wherein at least one electronically conductive polymer is selected from the group consisting of: polypyrrole (PPy), polythiophene (PTh), polydopamine, poly(3,4-ethylenedioxythiophene) (PEDOT), poly(3,4-propylenedioxythiophene) (ProDOT), poly(3,4-ethylenedioxypyrrole) (PEDOP), poly(3,4-propylenedioxypyrrole) (ProDOP), poly(3,4-ethylenedithiopyrrole) (PEDTP), poly(3,4-ethyleneoxyhiathiophene) (PEOTT), poly(3,4-ethylenedioxyselenophene) (PEDOSe), and derivatives, mixtures or copolymers thereof.

Embodiment 17. The nanostructured material of embodiment 14, wherein at least one electronically conductive polymer is selected from the group consisting of: polyaniline (PAni), poly(o-methylaniline) (POTO), poly(o-methoxyaniline) (POAS), poly(2,5-dimethylaniline) (PDMA), poly(2,5-dimethoxyaniline) (PDOA), sulfonated polyaniline (SPAN), poly(l-aminonaphthalene) (PNA), poly(5-aminonaphthalene-2-sulfonic acid), polyphenylene sulfide, and derivatives, mixtures or copolymers thereof.

Embodiment 18. The nanostructured material of embodiment 16 further comprising at least one electronically conductive polymer is selected from the group consisting of: polyaniline (PAni), poly(o-methylaniline) (POTO), poly(o-methoxyaniline) (POAS), poly(2,5-dimethylaniline) (PDMA), poly(2,5-dimethoxyaniline) (PDOA), sulfonated polyaniline (SPAN), poly(l-aminonaphthalene) (PNA), poly(5-aminonaphthalene-2-sulfonic acid), polyphenylene sulfide, and derivatives, mixtures or copolymers thereof.

Embodiment 19. The nanostructured material of embodiments 13 to 18, wherein the polymer is cross-linked.

Embodiment 20. The nanostructured material of any one of embodiments 2 to 12, wherein the membrane comprises an inorganic solid selected from the group consisting of, silicon carbide, silicon oxide, iron oxide, manganese oxide, titanium disulfide, molybdenum disulfide, zirconium oxide, titanium oxide, zeolites, and mixtures thereof.

Embodiment 21. The nanostructured material of any one of embodiments 2 to 12, wherein the membrane comprises a polymer with dispersed organic or inorganic matrices.

Embodiment 22. The nanostructured material of embodiment 21, wherein the organic or inorganic matrices are selected from the group consisting of: carbon matrices and zeolites.

Embodiment 23. The nanostructured material of embodiment 2, wherein the contained liquid phase comprises one or more substances that exchange across the permeable membrane.

Embodiment 24. The nanostructured material of embodiment 23, wherein movement of the substances in the contained liquid phase across the permeable membrane is induced by changes in hydrostatic pressure.

Embodiment 25. The nanostructured material of embodiment 3, wherein the contained liquid phase comprises at least one substance to which the selectively permeable membrane is substantially impermeable.

Embodiment 26. The nanostructured material of embodiment 25, wherein an impermeable substance is lithium polysulfide.

Embodiment 27. The nanostructured material of embodiment 25, wherein the at least one impermeable substance is a trapped solvent.

Embodiment 28. The nanostructured material of embodiment 27, wherein the trapped solvent is selected from the group consisting of: ethers, diethers, polyethers, sulfones, disulfones, polysulfones, nitriles, dinitriles, polynitriles, thioesters, dithioesters, thiocarbonates, dithiocarbonates, trithiocarbonates, or mixtures thereof.

Embodiment 29. An electrode composition comprising the nanostructured material of any one of the preceding embodiments.

Embodiment 30. The electrode composition of embodiment 29, further comprising one or more electrically conductive additive and one or more binders.

Embodiment 31. The electrode composition of embodiment 29, wherein the nanostructured material comprises at least 50% of the composition.

Embodiment 32. The electrode composition of embodiment 31, wherein the nanostructured material comprises about 60 to 90% of the composition.

Embodiment 33. A cathode formulated with the electrode composition of any one of embodiments 29 to 32.

Embodiment 34. An electrochemical energy storage device comprising the cathode of embodiment 33, an anode, a separator, and a primary electrolyte.

Embodiment 35. The electrochemical energy storage device of embodiment 34, wherein the primary electrolyte and the contained liquid in the nanostructured materials comprise different compositions.

Embodiment 36. A system comprising a nanostructured material in contact with a first liquid phase, the nanostructured material comprising a contained volume that encloses a contained electroactive substance and a contained liquid phase in contact with the electroactive substance wherein the contained liquid phase is physically separated from the first liquid phase by a selectively permeable membrane and wherein at least one of the first liquid phase and the contained liquid phase comprises substances to which the selectively permeable structure is substantially impermeable.

Embodiment 37. The system of embodiment 36, wherein the nanostructured material is from any one of embodiments 3 to 22 or 25 to 28.

Embodiment 38. The system of embodiment 36 or 37, wherein the contained liquid phase comprises one or more ethers to which the selectively permeable structure is substantially impermeable.

Embodiment 39. The system of any one of embodiments 36 to 38, wherein the first liquid phase comprises one or more aliphatic carbonates to which the selectively permeable structure is substantially impermeable.

Embodiment 40. A method of making a nanostructure comprising the steps of: forming a nanoscale particle of an electroactive substance; coating the nanoscale particle with a permeable encapsulant to contain the electroactive substance; reducing the volume of the contained electroactive substance to create a void space contained within the encapsulant; introducing a liquid phase into the void space; and coating the nanoscale particle with a second encapsulant that is impermeable to one or more of the substances in the liquid phase.

Embodiment 41. A method of making a nanostructure comprising the steps of: forming a nanoscale particle of an electroactive substance; coating the nanoscale particle with a permeable encapsulant to contain the electroactive substance; reducing the volume of the contained electroactive substance to create a void space contained within the encapsulant; introducing a liquid phase into the void space; and modifying the encapsulant to make it less permeable to one or more substances in the liquid phase.

Embodiment 42. A method of making a nanostructure comprising the steps of: forming a hollow structure with a permeable encapsulant, introducing a nanoscale particle of an electroactive substance into the hollow structure, introducing a liquid phase into the void space, and modifying the encapsulant to make it less permeable to one or more substances in the liquid phase.

Embodiment 43. A method of making a nanostructure comprising the steps of: forming a hollow structure with a permeable encapsulant; introducing a liquid phase into the void space comprising a dissolved electroactive substance or precursor to the electroactive substance; treating the nanostructure to solidify the dissolved electroactive substance or precursor to the electroactive substance contained in the hollow structure; and modifying the encapsulant to make it less permeable to one or more substances in the liquid phase.

Embodiment 44. The method of any one of embodiments 41 to 43, wherein the encapsulant comprises at least one polymer.

Embodiment 45. The method of embodiment 44, wherein the at least one polymer is selected from the group consisting of: polyethylene, polypropylene, polytetrafluoroethylene (PTFE), polyvinylidene difluoride (PVDF), polysulfone, polyethersulfone, polyacrylonitrile, polyamide, polyimide, polyamideimide, polyetherimide, cellulose acetate, polyaniline, polypyrrole, polyetheretherketone (PEEK), polybenzimidazole, and derivatives, mixtures, or copolymers thereof.

Embodiment 46. The method of embodiment 44, wherein at least one polymer is an electronically conducting polymer.

Embodiment 47. The method of embodiment 46, wherein at least one electronically conductive polymer is selected from the group consisting of: polyaniline, polydopamine, polypyrrole, polyselenophene, polythiophene, polynaphthalene, polyphenylene sulfide, and derivatives, mixtures, or copolymers thereof.

Embodiment 48. The method of embodiment 46, wherein at least one electronically conductive polymer is selected from the group consisting of: polypyrrole (PPy), polythiophene (PTh), polydopamine, poly(3,4-ethylenedioxythiophene) (PEDOT), poly(3,4-propylenedioxythiophene) (ProDOT), poly(3,4-ethylenedioxypyrrole) (PEDOP), poly(3,4-propylenedioxypyrrole) (ProDOP), poly(3,4-ethylenedithiopyrrole) (PEDTP), poly(3,4-ethyleneoxyhiathiophene) (PEOTT), poly(3,4-ethylenedioxyselenophene) (PEDOSe), and derivatives, mixtures or copolymers thereof.

Embodiment 49. The method of embodiment 46, wherein at least one electronically conductive polymer is selected from the group consisting of: polyaniline (PAni), poly(o-methylaniline) (POTO), poly(o-methoxyaniline) (POAS), poly(2,5-dimethylaniline) (PDMA), poly(2,5-dimethoxyaniline) (PDOA), sulfonated polyaniline (SPAN), poly(l-aminonaphthalene) (PNA), poly(5-aminonaphthalene-2-sulfonic acid), polyphenylene sulfide, and derivatives, mixtures or copolymers thereof.

Embodiment 50. The method of embodiment 48 further comprising at least one polymer is selected from the group consisting of: polyaniline (PAni), poly(o-methylaniline) (POTO), poly(o-methoxyaniline) (POAS), poly(2,5-dimethylaniline) (PDMA), poly(2,5-dimethoxyaniline) (PDOA), sulfonated polyaniline (SPAN), poly(l-aminonaphthalene) (PNA), poly(5-aminonaphthalene-2-sulfonic acid), polyphenylene sulfide, and derivatives, mixtures or copolymers thereof.

Embodiment 51. The method of any one of embodiments 44 to 45, wherein the step of modifying the permeability of the encapsulant comprises cross-linking the polymer.

Embodiment 52. The method of embodiment 51, wherein the polymer is cross-linked with one or more cross-linking reagent selected from the group consisting of: aldehydes, dicarbonyl compounds, sulfur or polysulfur compounds, diacid chlorides, alkyl dihalides, diamines, di-epoxides, polyisocyanates, and mixtures thereof.

Embodiment 53. The method of any one of embodiments 41 to 43, wherein the step of modifying the permeability of the encapsulant comprises acid doping and dedoping.

Embodiment 54. The method of embodiment 53, wherein the acid is selected from the group consisting of: acetic acid, decyl benzene sulfonic acid, camphor sulfonic acid, carboxylic acids, halogenic acids, p-phenol sulfonic acid, or combinations thereof.

1. A nanostructured material comprising a contained volume that is physically separated from a volume outside of the nanostructure, wherein the contained volume encloses a contained electroactive substance and a contained liquid phase in contact with the contained electroactive substance.

2. The nanostructured material of claim 1, wherein the contained volume is separated from the volume outside of the nanostructure by a selectively permeable membrane.

3. The nanostructured material of claim 1, wherein the electroactive substance comprises sulfur.

4. The nanostructured material of claim 3, wherein the electroactive substance is selected from the group consisting of: elemental sulfur; sulfur-containing organic molecules, polymers or composites; metal sulfides; and mixtures of any two or more of these.

5. The nanostructured material of claim 4, wherein the electroactive substance comprises S₈.

6. The nanostructured material of any one of the preceding claims, wherein the electroactive substance comprises about 20% to about 80% of the contained volume.

7. The nanostructured material of any one of the preceding claims, wherein the contained liquid phase comprises about 20% to about 80% of the contained volume.

8. The nanostructured material of any one of claims 2 to 7, wherein the selectively permeable membrane comprises a polymer selected from the group consisting of: polyethylene, polypropylene, polytetrafluoroethylene (PTFE), polyvinylidene difluoride (PVDF), polysulfone, polyethersulfone, polyacrylonitrile, polyamide, polyimide, polyamideimide, polyetherimide, cellulose acetate, polyaniline, polypyrrole, polyetheretherketone (PEEK), polybenzimidazole, and derivatives, mixtures or co-polymers thereof.

9. The nanostructured material of any one of claims 2 to 7, wherein the membrane comprises one or more electronically conductive polymers.

10. The nanostructured material of claim 9,
wherein at least one electronically conductive polymer is selected from the group consisting of: polyaniline, polydopamine, polypyrrole, polyselenophene, polythiophene, polynaphthalene, polyphenylene sulfide, and derivatives, mixtures or copolymers thereof; or
wherein at least one electronically conductive polymer is selected from the group consisting of: polypyrrole (PPy), polythiophene (PTh), polydopamine, poly(3,4-ethylenedioxythiophene) (PEDOT), poly(3,4-propylenedioxythiophene) (ProDOT), poly(3,4-ethylenedioxypyrrole) (PEDOP), poly(3,4-propylenedioxypyrrole) (ProDOP), poly(3,4-ethylenedithiopyrrole) (PEDTP), poly(3,4-ethyleneoxyhiathiophene) (PEOTT), poly(3,4-ethylenedioxyselenophene) (PEDOSe), and derivatives, mixtures or copolymers thereof; or
wherein at least one electronically conductive polymer is selected from the group consisting of: polyaniline (PAni), poly(o-methylaniline) (POTO), poly(o-methoxyaniline) (POAS), poly(2,5-dimethylaniline) (PDMA), poly(2,5-dimethoxyaniline) (PDOA), sulfonated polyaniline (SPAN), poly(1-aminonaphthalene) (PNA), poly(5-aminonaphthalene-2-sulfonic acid), polyphenylene sulfide, and derivatives, mixtures or copolymers thereof.

11. The nanostructured material of claim 10 further comprising at least one electronically conductive polymer is selected from the group consisting of: polyaniline (PAni), poly(o-methylaniline) (POTO), poly(o-methoxyaniline) (POAS), poly(2,5-dimethylaniline) (PDMA), poly(2,5-dimethoxyaniline) (PDOA), sulfonated polyaniline (SPAN), poly(l-aminonaphthalene) (PNA), poly(5-aminonaphthalene-2-sulfonic acid), polyphenylene sulfide, and derivatives, mixtures or copolymers thereof.

12. The nanostructured material of claims 8 to 11, wherein the polymer is cross-linked.

13. The nanostructured material of claim 2, wherein the contained liquid phase comprises one or more substances that exchange across the selectively permeable membrane.

14. The nanostructured material of claim 2, wherein the contained liquid phase comprises at least one substance to which the selectively permeable membrane is substantially impermeable.

15. The nanostructured material of claim 14, wherein an impermeable substance is lithium polysulfide.

16. The nanostructured material of claim 14, wherein the at least one impermeable substance is a trapped solvent.

17. The nanostructured material of claim 16, wherein the trapped solvent is selected from the group consisting of: ethers, diethers, polyethers, sulfones, disulfones, polysulfones, nitriles, dinitriles, polynitriles, thioesters, dithioesters, thiocarbonates, dithiocarbonates, trithiocarbonates, or mixtures thereof.

18. An electrode composition comprising the nanostructured material of any one of the preceding claims.

19. A cathode formulated with the electrode composition of claim 18.

20. An electrochemical energy storage device comprising the cathode of claim 19, an anode, a separator, and a primary electrolyte.

21. The electrochemical energy storage device of claim 20, wherein the primary electrolyte and the contained liquid in the nanostructured materials comprise different compositions.

22. A system comprising a nanostructured material in contact with a first liquid phase, the nanostructured material comprising a contained volume that encloses a contained electroactive substance and a contained liquid phase in contact with the electroactive substance wherein the contained liquid phase is physically separated from the first liquid phase by a selectively permeable membrane and wherein at least one of the first liquid phase and the contained liquid phase comprises substances to which the selectively permeable structure is substantially impermeable.

23. The system of claim 22, wherein the contained liquid phase comprises one or more ethers to which the selectively permeable structure is substantially impermeable.

24. The system of claim 22, wherein the first liquid phase comprises one or more aliphatic carbonates to which the selectively permeable structure is substantially impermeable.

25. A method of making a nanostructure comprising the steps of:
forming a nanoscale particle of an electroactive substance;
coating the nanoscale particle with a permeable encapsulant to contain the electroactive substance;
reducing the volume of the contained electroactive substance to create a void space contained within the encapsulant;
introducing a liquid phase into the void space; and
coating the nanoscale particle with a second encapsulant that is impermeable to one or more of the substances in the liquid phase.

26. A method of making a nanostructure comprising the steps of:
forming a nanoscale particle of an electroactive substance;
coating the nanoscale particle with a permeable encapsulant to contain the electroactive substance;
reducing the volume of the contained electroactive substance to create a void space contained within the encapsulant;
introducing a liquid phase into the void space; and
modifying the encapsulant to make it less permeable to one or more substances in the liquid phase.

27. A method of making a nanostructure comprising the steps of:
forming a hollow structure with a permeable encapsulant,
introducing a nanoscale particle of an electroactive substance into the hollow structure,
introducing a liquid phase into the void space, and
modifying the encapsulant to make it less permeable to one or more substances in the liquid phase.

28. A method of making a nanostructure comprising the steps of:
forming a hollow structure with a permeable encapsulant;
introducing a liquid phase into the void space comprising a dissolved electroactive substance or precursor to the electroactive substance;
treating the nanostructure to solidify the dissolved electroactive substance or precursor to the electroactive substance contained in the hollow structure; and
modifying the encapsulant to make it less permeable to one or more substances in the liquid phase.

29. The method of any one of claims 25 to 28, wherein the encapsulant comprises at least one polymer.

30. The method of claim 29, wherein at least one polymer is an electronically conducting polymer.

31. The method of any one of claims 26 to 28, wherein the step of modifying the permeability of the encapsulant comprises cross-linking a polymer.

32. The method of any one of claim 31, wherein the step of modifying the permeability of the encapsulant comprises acid doping and dedoping.
